(19) United States
(12) Patent Application Publication
(10) Pub. No.: US 2023/0105866 A1
(43) Pub. Date: Apr. 6, 2023

(54) ELECTROLYTE AND ELECTROCHEMICAL APPARATUS AND ELECTRONIC APPARATUS USING SAME

(71) Applicant: Ningde Amperex Technology Limited, Ningde (CN)

(72) Inventors: Xiang WANG, Ningde (CN); Wenqiang LI, Ningde (CN); Chao TANG, Ningde (CN); Jianming ZHENG, Ningde (CN)

(73) Assignee: Ningde Amperex Technology Limited, Ningde (CN)

(21) Appl. No.: 18/073,007

(22) Filed: Dec. 1, 2022

Related U.S. Application Data
(63) Continuation of application No. PCT/CN2020/093792, filed on Jun. 1, 2020.

(51) Int. Cl. H01M 10/0567; H01M 10/0525; H01M 10/0568

(52) U.S. Cl. CPC H01M 10/0567; H01M 10/0525; H01M 10/0568

(57) ABSTRACT

An electrolyte, including a carbonyl triazole compound or a thiocarbonyl triazole compound. Also, an electrochemical apparatus including a positive electrode, a negative electrode, and the electrolyte, and an electronic apparatus including the electrochemical apparatus. The electrolyte can improve high-temperature cycling performance of electrochemical apparatuses under high voltage conditions and reduce cycling resistance growth rate of the electrochemical apparatuses.

### CROSS-REFERENCE TO RELATED APPLICATIONS

This application is the continuation application of PCT international application: PCT/CN2020/093792 filed on Jun. 1, 2020, the disclosure of which is hereby incorporated by reference in its entirety.

### TECHNICAL FIELD

This application relates to the field of energy storage, and specifically, to an electrolyte and an electrochemical apparatus and electronic apparatus using the same.

### BACKGROUND

With the development of society, electrical products have been widely used in all aspects of production and life. People have a growing demand for light and small electrical products, imposing increasingly high requirements on electrochemical apparatuses (for example, lithium-ion batteries). In development of lithium-ion batteries with high energy density, a voltage upper limit designed for lithium-ion batteries is also increased. For example, a rated voltage of lithium cobalt oxide batteries in the market can be up to 4.45V or higher. However, at high voltages, an electrolyte in a lithium-ion battery experiences performance degradation, and even decomposes due to structural damage of a positive electrode and a negative electrode. Existing electrolyte additives are unable to provide sufficient protection at high voltages, but tends to trigger side reactions, which further deteriorates performance of lithium-ion batteries.

In view of this, it is indeed necessary to provide an improved electrolyte suitable for high voltage working conditions, as well as an electrochemical apparatus and electronic apparatus using such electrolyte.

### SUMMARY

This application provides an electrolyte and an electrochemical apparatus and electronic apparatus using the same, in an attempt to resolve at least one problem existing in the related field to at least some extent.

According to an aspect of this application, this application provides an electrolyte, including a compound represented by formula (I):

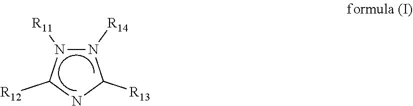

where:

R₁₁, R₁₂, R₁₃, and R₁₄ are each independently selected from a hydrogen atom, substituted or unsubstituted C₁-C₂₀ hydrocarbyl groups, or substituted or unsubstituted C₁-C₂₀ organic functional groups containing heteroatoms; and

at least one of R₁₁, R₁₂, R₁₃, or R₁₄ is

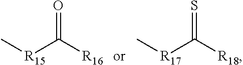

where:

R₁₅ and R₁₇ are each independently selected from a single bond, substituted or unsubstituted C₁-C₄ alkylidene groups, substituted or unsubstituted C₂-C₄ alkenylene groups, or substituted or unsubstituted C₆-C₁₀ arylene groups; and

R₁₆ and R₁₈ are each independently selected from substituted or unsubstituted C₁-C₁₀ hydrocarbyl groups or substituted or unsubstituted C₁-C₁₀ organic functional groups containing heteroatoms;

where the heteroatom is selected from at least one of oxygen, nitrogen, sulfur, phosphorus, silicon, or aluminum; and

when at least one of R₁₁, R₁₂, R₁₃, R₁₄, R₁₅, R₁₆, R₁₇, or R₁₈ is substituted, a substituent group is halogen or —CN.

According to an embodiment of this application, the compound represented by formula (I) includes at least one of compounds represented by formula (I-a) to formula (I-d):

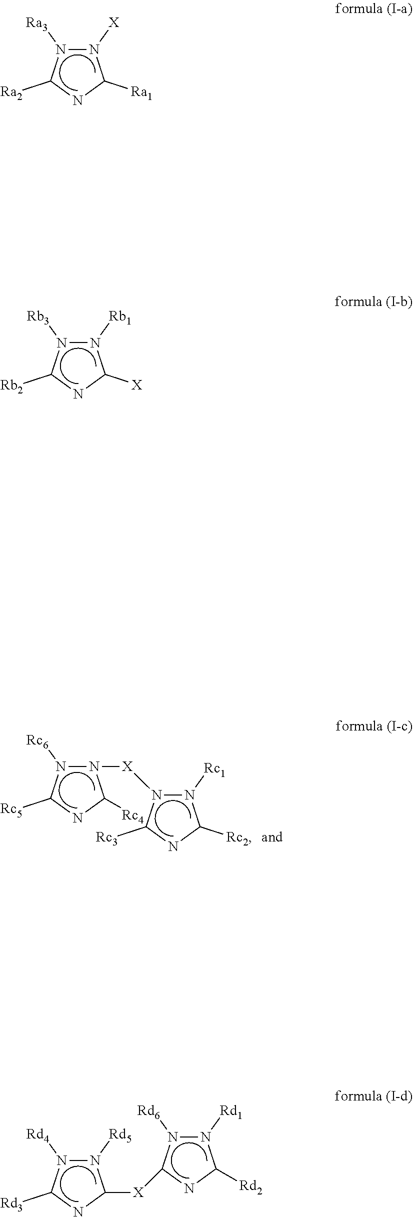

where:

X is selected from

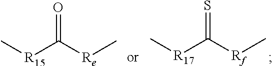

Ra₁, Ra₂, Ra₃, Rb₁, Rb₂, Rb₃, Rc₁, Rc₂, Rc₃, Rc₄, Rc₅, Rc₆, Rd₁, Rd₂, Rd₃, Rd₄, Rd₅, and Rd₆ are each independently selected from a hydrogen atom, substituted or unsubstituted C₁-C₂₀ alkyl groups, substituted or unsubstituted C₂-C₂₀ alkenyl groups, substituted or unsubstituted C₂-C₂₀ alkynyl groups, substituted or unsubstituted C₆-C₃₀ aryl groups, substituted or unsubstituted C₁-C₂₀ alkoxy groups, substituted or unsubstituted C₂-C₂₀ alkenyloxy groups, substituted or unsubstituted C₂-C₂₀ alkynyloxy groups, substituted or unsubstituted C₆-C₃₀ aryloxy groups, carboxyl group, ether group, carbonyloxy group, sulfhydryl group, cyan group, amido group, carbonamide group, substituted or unsubstituted C₁-C₁₆ siloxy groups, C₁-C₁₆ alumina alkyl groups, substituted or unsubstituted C₁-C₁₀ saturated cycloalkyl groups, substituted or unsubstituted furanyl groups, substituted or unsubstituted pyranyl groups, substituted or unsubstituted piperidinyl groups, substituted or unsubstituted piperazinyl groups, substituted or unsubstituted pyrrolyl groups, substituted or unsubstituted pyrazolyl groups, substituted or unsubstituted pyrazinyl groups, substituted or unsubstituted pyridazinyl groups, substituted or unsubstituted imidazolyl groups, substituted or unsubstituted triazolyl groups, substituted or unsubstituted thienyl groups, substituted or unsubstituted thiazolyl groups, or substituted or unsubstituted oxazolyl groups;

R₁₅, Rₑ, R₁₇, and R_{f} are each independently selected from a bond, substituted or unsubstituted C₁-C₄ alkylidene groups, substituted or unsubstituted C₂-C₄ alkenylene groups, or substituted or unsubstituted C₆-C₁₀ arylidene groups; and

when at least one of Ra₁, Ra₂, Ra₃, Rb₁, Rb₂, Rb₃, Rc₁, Rc₂, Rc₃, Rc₄, Rc₅, Rc₆, Rd₁, Rd₂, Rd₃, Rd₄, Rd₅, Rd₆, Rₑ, or R_{f} is substituted, a substituent group is halogen, C₁-C₆ alkyl groups, or —CN.

According to an embodiment of this application, the compound represented by formula (I) includes at least one of the following compounds:

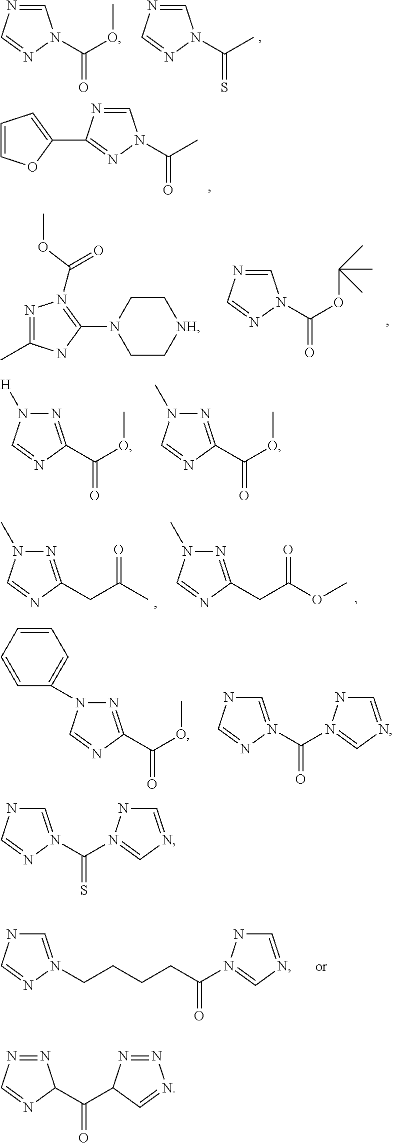

According to an embodiment of this application, based on a total weight of the electrolyte, a percentage of the compound represented by formula (I) is n wt %, where n is 0.02 to 6.

According to an embodiment of this application, the electrolyte further includes a first additive, where the first additive includes at least one of fluoroethylene carbonate or vinylene carbonate, and based on the total weight of the electrolyte, a percentage of the first additive is m wt %, where m>0, and m and n satisfy the following relationship: −1≤m−n≤18.

According to an embodiment of this application, the electrolyte further includes a second additive, where the second additive includes at least one of a compound represented by formula (II) or a compound represented by formula (III):

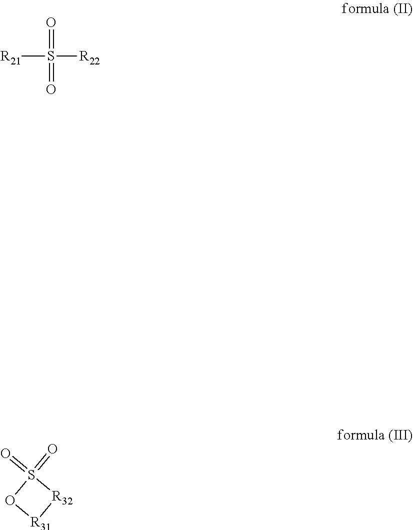

where:

R₂₁ and R₂₂ are each independently selected from substituted or unsubstituted C₁-C₂₀ alkyl groups, substituted or unsubstituted C₂-C₂₀ alkenyl groups, substituted or unsubstituted C₂-C₂₀ alkynyl groups, substituted or unsubstituted C₆-C₃₀ aryl groups, substituted or unsubstituted C₁-C₂₀ alkoxy groups, substituted or unsubstituted C₂-C₂₀ alkenyloxy groups, substituted or unsubstituted C₂-C₂₀ alkynyloxy groups, or substituted or unsubstituted C₆-C₃₀ aryloxy groups, and when at least one of R₂₁ or R₂₂ is substituted, a substituent group is halogen;

R₃₁ is selected from substituted or unsubstituted C₁-C₄ alkylidene groups or substituted or unsubstituted C₂-C₄ alkenylene groups;

R₃₂ is selected from a bond, substituted or unsubstituted C₁-C₂ alkyleneoxy groups, —O—, or —R₃₃—SO₂—R₃₄—;

R₃₃ is selected from substituted or unsubstituted C₁-C₂ alkylidene groups;

R₃₄ is selected from a bond, substituted or unsubstituted C₁-C₂ alkylidene groups, or —O—; and

when at least one of R₃₁, R₃₂, R₃₃, or R₃₄ is substituted, a substituent group is C₁-C₂₀ alkyl groups, C₆-C₃₀ aryl groups, halogen, or —CN; and

based on a total weight of the electrolyte, a percentage of the second additive is 0.05 wt % to 10 wt %.

According to an embodiment of this application, the second additive includes at least one of the following compounds:

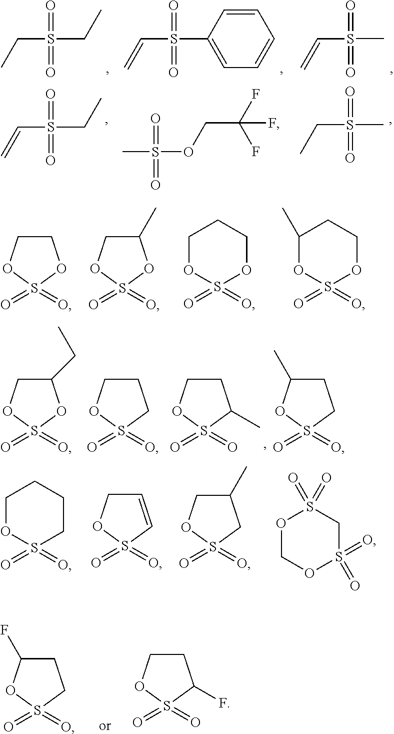

According to an embodiment of this application, the electrolyte further includes a third additive, where the third additive includes at least one of a compound having two nitrile groups or a compound having three or more nitrile groups, the compound having two nitrile groups includes at least one of a compound represented by formula (IV) or a compound represented by formula (V), and the compound having three or more nitrile groups includes at least one of a compound represented by formula (VI) or a compound represented by formula (VII);

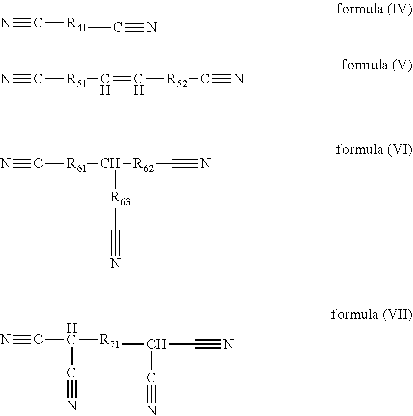

where:

R₄₁ is selected from substituted or unsubstituted C₁-C₁₂ alkylidene groups or —R^{c}—(O—R^{a})_{A}—O—R^{b}, and R^{a} and R^{b} are each independently selected from substituted or unsubstituted C₁-C₃ alkylidene groups, R^{c} is selected from a bond or substituted or unsubstituted C₁-C₃ alkylidene groups, where A is an integer between 0 and 2;

R₅₁ and R₅₂ are each independently selected from a bond or substituted or unsubstituted C₁-C₁₂ alkylidene groups;

R₆₁, R₆₂, and R₆₃ are each independently selected from a bond, substituted or unsubstituted C₁-C₁₂ alkylidene groups, or substituted or unsubstituted C₁-C₁₂ alkyleneoxy groups;

R₇₁ is selected from substituted or unsubstituted C₁-C₁₂ alkylidene groups, substituted or unsubstituted C₂-C₁₂ alkenylene groups, substituted or unsubstituted C₆-C₂₆ arylene groups, or substituted or unsubstituted C₂-C₁₂ heterocyclylene groups; and

when at least one of R₄₁, R₅₁, R₅₂, R₆₁, R₆₂, R₆₃, or R₇₁ is substituted, a substituent group is halogen; and

based on a total weight of the electrolyte, a percentage of the third additive is 0.1 wt % to 12 wt %.

According to an embodiment of this application, the third additive includes at least one of the following compounds: malononitrile, butanedinitrile, glutaronitrile, adiponitrile, heptanedinitrile, octanedinitrile, sebaconitrile, 3,3′-oxydipropionitrile, hex-2-enedinitrile, fumaronitrile, 2-pentenedirile, methylglutaronitrile, 4-cyanopimelonitrile, (Z)-but-2-enedinitrile, 2,2,3,3-tetrafluorosuccinonitrile, ethylene glycol bis(propionitrile) ether, 1,3,5-pentanetricarbonitrile, 1,3,6-hexanetricarbonitrile, 1,2,6-hexanetricarbonitrile, 1,2,3-tris(2-cyanooxy)propane, 1,1,3,3-propanetetracarbonitrile,

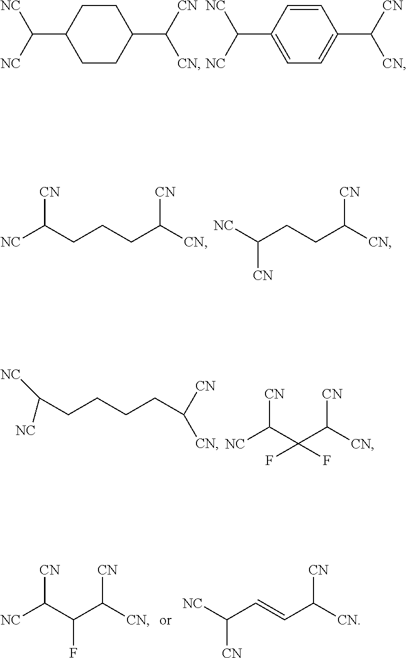

According to an embodiment of this application, based on the total weight of the electrolyte, a percentage of the compound having two nitrile groups is x wt %, and a percentage of the compound having three or more nitrile groups is y wt %, where x−y≥0.

According to an embodiment of this application, the electrolyte further includes a fourth additive, where the fourth additive includes at least one of LiCH₃SO₃, LiCF₃SO₃, LiN(SO₂CF₃)₂, LiC(SO₂CF₃)₃, LiBOB, or LiDFOB, and based on a total weight of the electrolyte, a percentage of the fourth additive is 0.05 wt % to 2 wt %.

According to another aspect of this application, this application provides an electrochemical apparatus, including a positive electrode, a negative electrode, and the electrolyte according to this application.

According to an embodiment of this application, the positive electrode includes a positive electrode active material, the positive electrode active material contains first particles and second particles, and an average particle size of the first particles is greater than an average particle size of the second particles.

According to an embodiment of this application, the first particle and the second particle have the same or different chemical compositions.

According to an embodiment of this application, the second particles contain element aluminum, and based on a total weight of the positive electrode active material, a percentage of element aluminum is 0.001 wt % to 1 wt %.

According to still another aspect of this application, this application provides an electronic apparatus, including the electrochemical apparatus according to this application.

Additional aspects and advantages of this application are partially described and presented in subsequent descriptions, or explained by implementation of the embodiments of this application.

### DETAILED DESCRIPTION

Embodiments of this application are described in detail below. The embodiments of this application should not be construed as limitations on the application.

In the specific embodiments and claims, a list of items connected by the term “at least one of” may mean any combination of the listed items. For example, if items A and B are listed, the phrase “at least one of A and B” means only A; only B; or A and B. In another example, if items A, B, and C are listed, the phrase “at least one of A, B, and C” means only A; only B; only C; A and B (exclusive of C); A and C (exclusive of B); B and C (exclusive of A); or all of A, B, and C. The item A may contain a single element or a plurality of elements. The item B may contain a single element or a plurality of elements. The item C may contain a single element or a plurality of elements. The term “at least one type of” has same meaning as the term “at least one of”.

The term “hydrocarbyl group” used herein covers an alkyl group, an alkenyl group, an alkynyl group, a cycloalkyl group, an aryl group, and the like.

The term “alkyl group” used herein is intended to be a straight-chain saturated hydrocarbon structure having 1 to 20 carbon atoms. The term “alkyl group” is also intended to be a branched or cycling hydrocarbon structure having 3 to 20 carbon atoms. References to an alkyl group with a specific carbon number are intended to cover all geometric isomers with the specific carbon number. Therefore, for example, “butyl” is meant to include n-butyl, sec-butyl, isobutyl, tert-butyl, and cyclobutyl; and “propyl” includes n-propyl, isopropyl, and cyclopropyl. Examples of the alkyl group include, but are not limited to, a methyl group, an ethyl group, an n-propyl group, an isopropyl group, an cyclopropyl group, an n-butyl group, an isobutyl group, a sec-butyl group, a tert-butyl group, a cyclobutyl group, an n-pentyl group, an isopentyl group, a neopentyl group, a cyclopentyl group, a methylcyclopentyl group, an ethylcyclopentyl group, an n-hexyl group, an isohexyl group, a cyclohexyl group, an n-heptyl group, an octyl group, a cyclopropyl group, a cyclobutyl group, and a norbornyl group.

The term “alkylidene group” used herein means a straight-chain or branched divalent saturated hydrocarbyl group. Unless otherwise defined, the alkylidene group generally contains 2 to 10 carbon atoms and includes, for example, C₂-C₃ alkylene groups and C₂-C₆ alkylene groups. Representative alkylidene groups include (for example) methylene, ethane-1,2-diyl (“ethylene”), propane-1,2-diyl, propane-1,3-diyl, butane-1,4-diyl, and pentane-1,5-diyl.

The term “alkenyl group” used herein refers to a straight-chain or branched monovalent unsaturated hydrocarbyl group having at least one and usually 1, 2, or 3 carbon-carbon double bonds. Unless otherwise defined, the alkenyl group generally contains 2 to 20 carbon atoms and includes (for example) C₂-C₄ alkenyl groups, C₂-C₆ alkenyl groups, and C₂-C₁₀ alkenyl groups. Representative alkenyl groups include (for example) vinyl, n-propenyl, isopropenyl, n-but-2-enyl, but-3-enyl, and n-hex-3-enyl.

The term “alkenylene group” used herein means a bifunctional group obtained by removing one hydrogen atom from the above-defined alkenylene group. Preferred alkenylene groups include but are not limited to —CH═CH—, —C(CH₃)═CH—, and —CH═CHCH₂—.

The term “alkynyl group” used herein refers to a straight-chain or branched monovalent unsaturated hydrocarbyl group having at least one and usually 1, 2, or 3 carbon-carbon triple bonds. Unless otherwise defined, the alkynyl generally contains 2 to 20 carbon atoms and includes (for example) a —C₂₋₄ alkynyl group, a —C₃₋₆ alkynyl group, and a —C₃₋₁₀ alkynyl. Representative alkynyl groups include (for example) ethynyl, prop-2-ynyl(n-propynyl), n-but-2-ynyl, and n-hex-3-ynyl.

The term “aryl group” means a monovalent aromatic hydrocarbon having a monocycling (for example, phenyl) or fused ring. A fused ring system includes fully unsaturated ring systems (for example, naphthalene) and partially unsaturated ring systems (for example, 1,2,3,4-tetrahydronaphthalene). Unless otherwise defined, the alkynyl group generally contains 6 to 30 carbocycling atoms and includes, for example, C₆-C₁₀ aryl groups. Representative aryl groups include (for example) phenyl, methylphenyl, propylphenyl, isopropylphenyl, benzyl, naphth-1-yl, and naphth-2-yl.

The term “arylene group” covers both monocycling and polycycling systems. A polycycling ring may have two or more rings in which two carbons are shared by two adjacent rings (the rings are “fused”), where at least one of the rings is aromatic, and other rings, for example, may be a cycloalkyl group, a cycloalkenyl group, an aryl group, a heterocyclyl, and/or a heteroaryl group. For example, the arylene group may be C₆-C₃₀ arylene groups, C₆-C₂₆ arylene groups, C₆-C₂₀ arylene groups, or C₆-C₁₀ arylene groups.

The term “alkoxy group” used herein refers to an alkyl group attached to an oxygen atom, where the alkyl group has the meaning as described herein. The alkoxy group may be an alkoxy group having 1 to 20 carbon atoms, an alkoxy group having 1 to 8 carbon atoms, an alkoxy group having 1 to 5 carbon atoms, an alkoxy group having 5 to 10 carbon atoms, or an alkoxy group having 5 to 20 carbon atoms. Examples of the alkoxy group include, but are not limited to, methoxy, ethoxy, n-propoxy, isopropoxy, n-butoxy, sec-butoxy, tert-butoxy, n-pentoxy, and 5-pentoxy.

The term “alkenyloxy group” used herein refers to an alkenyl group attached to an oxygen atom, where the alkenyl group has the meaning as described herein. The alkenyloxy group may be an alkenyloxy group having 2 to 20 carbon atoms, an alkenyloxy group having 2 to 10 carbon atoms, an alkenyloxy group having 2 to 8 carbon atoms, and an alkenyloxy group having 2 to 6 carbon atoms. Examples of the alkenyloxy group include, but are not limited to, propenyloxy, butenyloxy, pentenyloxy, hexenyloxy, heptenyloxy, and octenyloxy.

The term “alkynyloxy group” used herein refers to an alkynyloxy group attached to an oxygen atom, where the alkynyloxy group has the meaning as described herein. The alkynyloxy group may be an alkynyloxy group having 2 to 20 carbon atoms, an alkynyloxy group having 2 to 10 carbon atoms, an alkynyloxy group having 2 to 8 carbon atoms, and an alkynyloxy group having 2 to 6 carbon atoms. Examples of the alkynyloxy group include, but are not limited to, ethynyloxy, 1-propynyloxy, 1-butynyloxy, 1-pentynyloxy, and 1-hexynyloxy.

The term “aryloxy group” used herein refers to an aryl group attached to an oxygen atom, where the aryl group has the meaning as described herein. The aryloxy group may be an aryloxy group having 6 to 30 carbon atoms, an aryloxy group having 6 to 26 carbon atoms, an aryloxy group having 6 to 20 carbon atoms, and an aryloxy group having 6 to 10 carbon atoms. Examples of the aryloxy group include, but are not limited to, phenoxymethyl and phenoxyethyl.

The term “siloxy group” used herein refers to an alkyl group attached to a —Si—O— atom, where the alkyl group has the meaning as described herein.

The term “alumina alkyl group” used herein refers to an alkyl group attached to an —Al—O— group, where the alkyl group has the meaning as described herein.

The term “organic functional group containing heteroatoms” used herein refers to a chain group containing heteroatoms or a group containing heterocycles. “Chain group” refers to a straight or branched chain group having 1 to 20 carbon atoms (or having 3 to 10 carbon atoms or having 2 to 5 carbon atoms). Examples of chain groups containing heteroatoms include, but are not limited to, methoxy, ethoxy, propoxy, isopropyloxy, n-butyloxy, vinyloxy, propyleneoxy, ethynyloxy, formaldehyde group, cyano group, acetonitrile group, ethylamine group, acetoxy group, acetamido group, diethyl ether group, methyl sulfide group, methyl disulfide group, methyl diazo group, ethane sulfonic acid group, ethane sulfinic acid group, ethane phosphate, ethane phosphite, ethane phosphite, methyl triacetone oxime, methylbutylketoximino, methylsiloxane, methylsilazane, and methylaluminoxane.

The term “heterocycle” or “heterocyclyl” used herein means a stable monocycling, bicycling or tricycling ring containing a heteroatom or a group of heteroatoms, which may be saturated, partially unsaturated or unsaturated (aromatic), and contain 3 to 10 carbon atoms (or 3 to 8 carbon atoms, or 3 to 6 carbon atoms) and 1, 2, 3, or 4 ring heteroatoms independently selected from N, O, S, P, Si, or Al. Any of the above heterocycles can be fused onto a benzene ring to form a bicycling ring. Heterocycles can include, but are not limited to, furan, pyran, piperidine, piperazine, pyrrole, pyrazol, pyrazine, pyridazine, imidazole, triazole, thiophene, thiazole, or oxazole. Examples of heterocyclyl groups include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuranindol-3-yl, tetrahydrothiophen-2-yl, tetrahydrothiophen-3-yl, 1-piperazinyl, and 2-piperazinyl.

The term “heterocyclylene” used herein refers to a divalent heterocyclyl group. Examples of heterocyclylene include, but are not limited to oxiranyl(ene), aziridinyl(ene), azetidinyl(ene), oxetanyl(ene) (oxetanyl), tetrahydrofuranyl(ene), dioxolinyl(ene) (dioxolinyl), pyrrolidinyl(ene), pyrrolidonyl(ene), imidazolidinyl(ene), pyrazolidinyl(ene), pyrrolinyl(ene), tetrahydropyranyl(ene), piperidinyl(ene), morpholinyl(ene), dithianyl(ene) (dithianyl), thiomorpholinyl(ene), piperazinyl(ene), or trithianyl(ene) (trithianyl).

The term “heteroatom” used herein refers to at least one of N, O, S, P, Si, or Al.

The term “cyano group” used herein covers organic substances containing an organic group —CN.

The term “halogen” used herein refers to a stable atom belonging to Group 17 of the Periodic Table of the Elements, such as fluorine, chlorine, bromine, or iodine.

The term “substituted or unsubstituted” used herein means that a specific group is unsubstituted or substituted with one or more substituent groups. Unless otherwise specified, when the foregoing substituent groups are substituted, the substituent groups may be selected from a group including the following: halogen, alkyl, cycloalkyl, alkenyl, aryl, heteroaryl, —CN, and the like.

Electrolyte

With the wide application of electrochemical apparatuses (for example, lithium-ion batteries), increasingly high requirements are imposed on performance of electrochemical apparatuses. In order to develop lithium-ion batteries with high energy density, a voltage upper limit designed for lithium-ion batteries is also increased. However, under high voltage conditions (for example, 4.45V or higher), oxidation resistance and film formation stability of conventional electrolytes decrease. In addition, oxygen is released due to damage of structures of positive and negative electrodes, which accelerates decomposition of the electrolytes. An effect of additives previously used for improving electrolyte performance is significantly reduced at high or even extreme voltages such that the additives cannot provide protection. Moreover, side reactions take place, deteriorating cycling performance of lithium-ion batteries. How to improve cycling performance of electrochemical apparatuses under high voltage working conditions has become one of the bottlenecks in research and development.

To resolve the foregoing problem, this application provides an electrolyte, where the electrolyte includes a compound represented by formula (I):

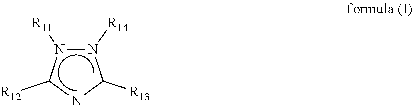

where:

R₁₁, R₁₂, R₁₃, and R₁₄ are each independently selected from a hydrogen atom, substituted or unsubstituted C₁-C₂₀ hydrocarbyl groups, or substituted or unsubstituted C₁-C₂₀ organic functional groups containing heteroatoms; and

at least one of R₁₁, R₁₂, R₁₃, or R₁₄ is

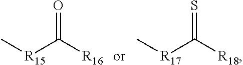

where:

R₁₅ and R₁₇ are each independently selected from a single bond, substituted or unsubstituted C₁-C₄ alkylidene groups, substituted or unsubstituted C₂-C₄ alkenylene groups, or substituted or unsubstituted C₆-C₁₀ arylene groups; and

R₁₆ and R₁₈ are each independently selected from substituted or unsubstituted C₁-C₁₀ hydrocarbyl groups or substituted or unsubstituted C₁-C₁₀ organic functional groups containing heteroatoms;

where the heteroatom is selected from at least one of oxygen, nitrogen, sulfur, phosphorus, silicon, or aluminum; and

when at least one of R₁₁, R₁₂, R₁₃, R₁₄, R₁₅, R₁₆, R₁₇, or R₁₈ is substituted, a substituent group is halogen or —CN.

According to an embodiment of this application, the compound represented by formula (I) includes at least one of compounds represented by formula (I-a) to formula (I-d):

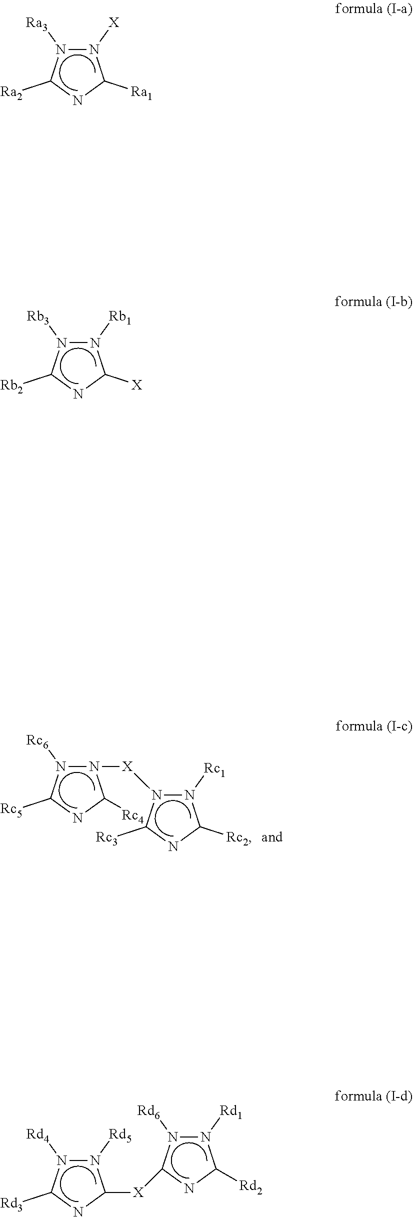

where:

X is selected from

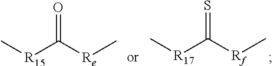

Ra₁, Ra₂, Ra₃, Rb₁, Rb₂, Rb₃, Rc₁, Rc₂, Rc₃, Rc₄, Rc₅, Rc₆, Rd₁, Rd₂, Rd₃, Rd₄, Rd₅, and Rd₆ are each independently selected from a hydrogen atom, substituted or unsubstituted C₁-C₂₀ alkyl groups, substituted or unsubstituted C₂-C₂₀ alkenyl groups, substituted or unsubstituted C₂-C₂₀ alkynyl groups, substituted or unsubstituted C₆-C₃₀ aryl groups, substituted or unsubstituted C₁-C₂₀ alkoxy groups, substituted or unsubstituted C₂-C₂₀ alkenyloxy groups, substituted or unsubstituted C₂-C₂₀ alkynyloxy groups, substituted or unsubstituted C₆-C₃₀ aryloxy groups, carboxyl group, ether group, carbonyloxy group, sulfhydryl group, cyan group, amido group, carbonamide group, substituted or unsubstituted C₁-C₁₆ siloxy groups, C₁-C₁₆ alumina alkyl groups, substituted or unsubstituted C₁-C₁₀ saturated cycloalkyl groups, substituted or unsubstituted furanyl groups, substituted or unsubstituted pyranyl groups, substituted or unsubstituted piperidinyl groups, substituted or unsubstituted piperazinyl groups, substituted or unsubstituted pyrrolyl groups, substituted or unsubstituted pyrazolyl groups, substituted or unsubstituted pyrazinyl groups, substituted or unsubstituted pyridazinyl groups, substituted or unsubstituted imidazolyl groups, substituted or unsubstituted triazolyl groups, substituted or unsubstituted thienyl groups, substituted or unsubstituted thiazolyl groups, or substituted or unsubstituted oxazolyl groups;

R₁₅, Rₑ, R₁₇, and R_{f} are each independently selected from a bond, substituted or unsubstituted C₁-C₄ alkylidene groups, substituted or unsubstituted C₂-C₄ alkenylene groups, or substituted or unsubstituted C₆-C₁₀ arylidene groups; and

when at least one of Ra₁, Ra₂, Ra₃, Rb₁, Rb₂, Rb₃, Rc₁, Rc₂, Rc₃, Rc₄, Rc₅, Rc₆, Rd₁, Rd₂, Rd₃, Rd₄, Rd₅, Rd₆, Rₑ, or R_{f} is substituted, a substituent group is halogen, C₁-C₆ alkyl groups, or —CN.

According to an embodiment of this application, the compound represented by formula (I) includes at least one of the following compounds:

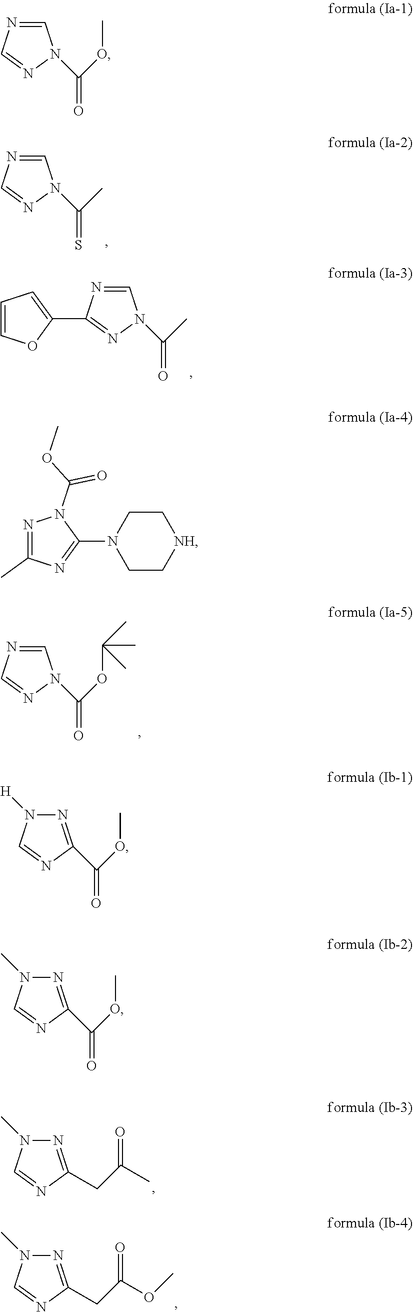

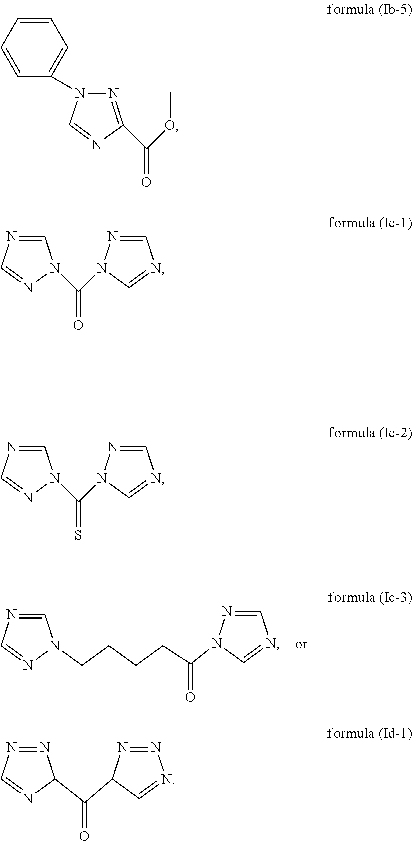 [SMILES: COC(=O)c1ncn(-c2ccccc2)n1 ; O=C(n1cncn1)n1cncn1 ; S=C(n1cncn1)n1cncn1 ; O=C(CCCCn1cncn1)n1cncn1 ; O=C(C1C=NN=N1)C1N=CN=N1]

The carbonyl triazole compound or thiocarbonyl triazole compound can open ring in the electrolyte to form a composite organic protective film. The composite organic protective film contains many electron-rich groups that are able to store ions and inhibit contact between a positive active material and the electrolyte, thereby significantly improving high-temperature cycling performance of electrochemical apparatuses under high voltage conditions and suppressing the resistance growth rate during cycling.

According to an embodiment of this application, based on a total weight of the electrolyte, a percentage of the compound represented by formula (I) is n wt %, where n is 0.02 to 6. In some embodiments, n is 0.05 to 5. In some embodiments, n is 0.1 to 4. In some embodiments, n is 0.3 to 3. In some embodiments, n is 0.5 to 2. In some embodiments, n is 0.8 to 1. In some embodiments, n is 0.02, 0.05, 0.08, 0.1, 0.2, 0.5, 0.8, 1, 1.5, 2, 2.5, 3, 3.5, 4, 4.5, 5, 5.5, or 6, or falls within a range defined by any two of the foregoing values. Percentage of the compound represented by formula (I) in the electrolyte being within the foregoing range helps further improve the high-temperature cycling performance of the electrochemical apparatuses under high voltage conditions and further reduce the cycling resistance growth rate of the electrochemical apparatuses.

According to an embodiment of this application, the electrolyte further includes a first additive, where the first additive includes at least one of fluoroethylene carbonate or vinylene carbonate, and based on the total weight of the electrolyte, a percentage of the first additive is m wt %, where m>0, and m and n satisfy the following relationship: −1≤m−n≤18. In some embodiments, m and n satisfy the following relationship: 0≤m−n≤15. In some embodiments, m and n satisfy the following relationship: 1≤m−n≤10. In some embodiments, m and n satisfy the following relationship: 3≤m−n≤5. In some embodiments, m−n is equal to −1, −0.5, 0, 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, or 18. Percentages of the first additive and the compound represented by formula (I) in the electrolyte satisfying the above relationship helps further improve the high-temperature cycling performance of the electrochemical apparatuses under high voltage conditions and further reduce the cycling resistance growth rate of the electrochemical apparatuses.

According to an embodiment of this application, the electrolyte further includes a second additive, where the second additive includes at least one of a compound represented by formula (II) or a compound represented by formula (III):

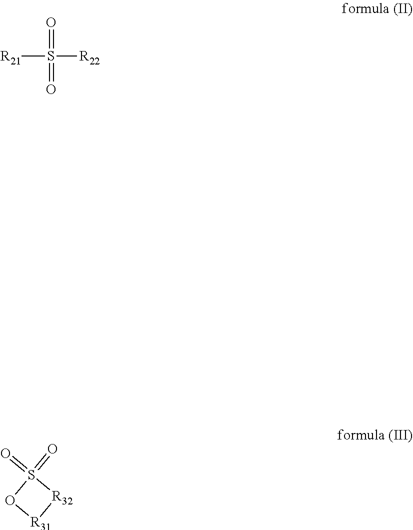

where:

R₂₁ and R₂₂ are each independently selected from substituted or unsubstituted C₁-C₂₀ alkyl groups, substituted or unsubstituted C₂-C₂₀ alkenyl groups, substituted or unsubstituted C₂-C₂₀ alkynyl groups, substituted or unsubstituted C₆-C₃₀ aryl groups, substituted or unsubstituted C₁-C₂₀ alkoxy groups, substituted or unsubstituted C₂-C₂₀ alkenyloxy groups, substituted or unsubstituted C₂-C₂₀ alkynyloxy groups, or substituted or unsubstituted C₆-C₃₀ aryloxy groups, and when at least one of R₂₁ or R₂₂ is substituted, a substituent group is halogen;

R₃₁ is selected from substituted or unsubstituted C₁-C₄ alkylidene groups or substituted or unsubstituted C₂-C₄ alkenylene groups;

R₃₂ is selected from a bond, substituted or unsubstituted C₁-C₂ alkyleneoxy groups, —O—, or —R₃₃—SO₂—R₃₄—;

R₃₃ is selected from substituted or unsubstituted C₁-C₂ alkylidene groups;

R₃₄ is selected from a bond, substituted or unsubstituted C₁-C₂ alkylidene groups, or —O—; and

when at least one of R₃₁, R₃₂, R₃₃, or R₃₄ is substituted, a substituent group is C₁-C₂₀ alkyl groups, C₆-C₃₀ aryl groups, halogen, or —CN.

According to an embodiment of this application, the second additive includes at least one of the following compounds:

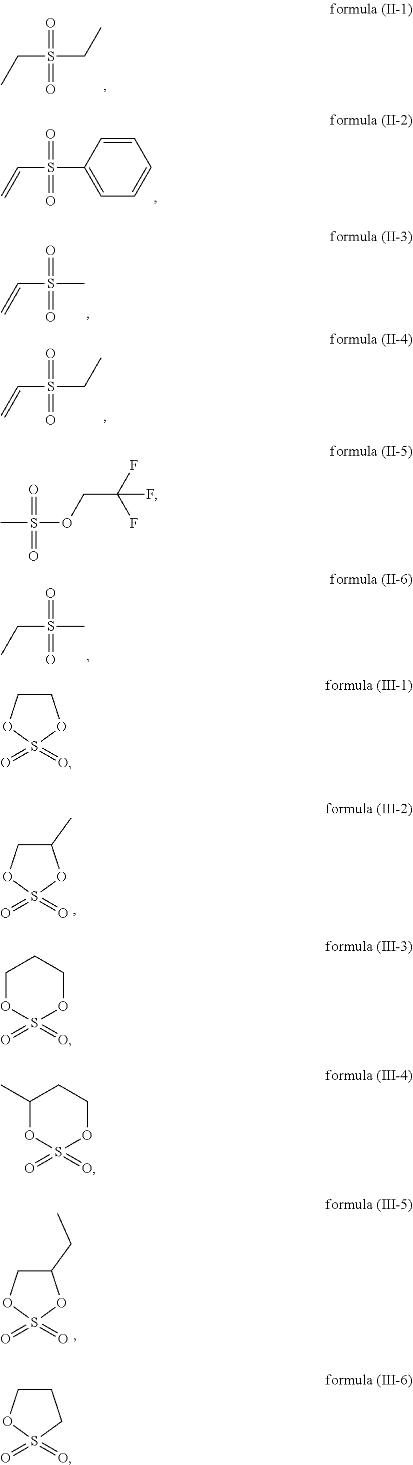

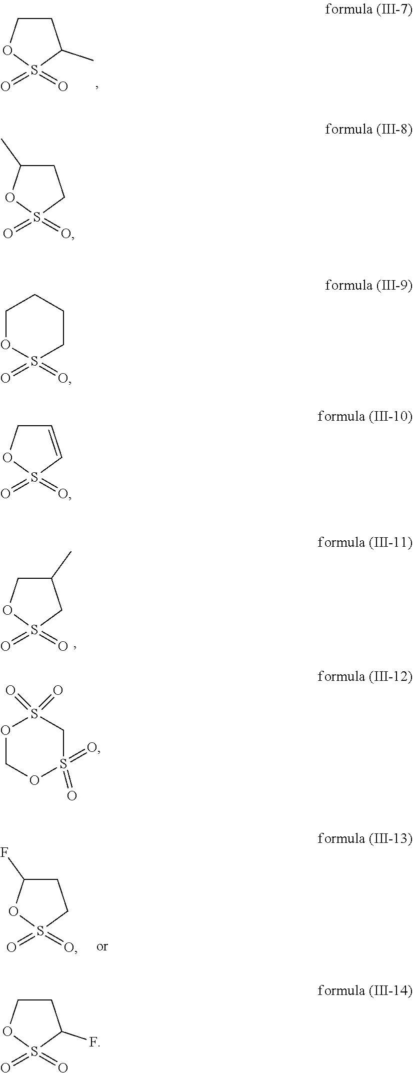

The second additive contains a

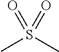

functional group, which has good film forming ability on positive and negative electrodes during first charging, and repairs a decomposed protective film during cycling. Adding the second additive on the basis of the compound represented by formula (I) further improves the high-temperature cycling performance of the electrochemical apparatuses under high voltage conditions and further reduces the cycling resistance growth rate of the electrochemical apparatuses.

According to an embodiment of this application, based on a total weight of the electrolyte, a percentage of the second additive is 0.05 wt % to 10 wt %. In some embodiments, based on the total weight of the electrolyte, a percentage of the second additive is 0.1 wt % to 8 wt %. In some embodiments, based on the total weight of the electrolyte, a percentage of the second additive is 0.5 wt % to 5 wt %. In some embodiments, based on the total weight of the electrolyte, a percentage of the second additive is 1 wt % to 3 wt %. In some embodiments, based on the total weight of the electrolyte, a percentage of the second additive is 0.05 wt %, 0.1 wt %, 0.3 wt %, 0.5 wt %, 0.8 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, or 10 wt %, or falls within a range defined by any two of the foregoing values. Percentage of the second additive in the electrolyte being within the foregoing range helps further improve the high-temperature cycling performance of the electrochemical apparatuses under high voltage conditions and further reduce the cycling resistance growth rate of the electrochemical apparatuses.

According to an embodiment of this application, the electrolyte further includes a third additive, where the third additive includes at least one of a compound having two nitrile groups and a compound having three or more nitrile groups, the compound having two nitrile groups includes at least one of a compound represented by formula (IV) or a compound represented by formula (V), and the compound having three or more nitrile groups includes at least one of a compound represented by formula (VI) or a compound represented by formula (VII):

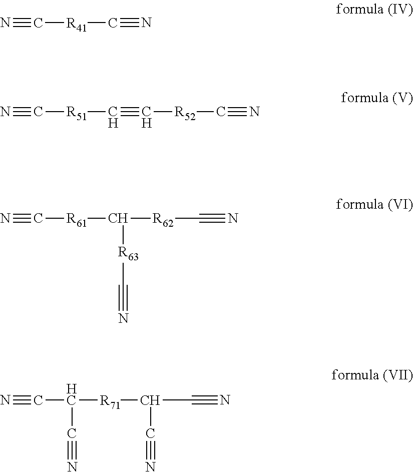

where:

R₄₁ is selected from substituted or unsubstituted C₁-C₁₂ alkylidene groups or —R^{c}—(O—R^{a})_{A}—O—R^{b}, and R^{a} and R^{b} are each independently selected from substituted or unsubstituted C₁-C₃ alkylidene groups, R^{c} is selected from a bond or substituted or unsubstituted C₁-C₃ alkylidene groups, where A is an integer between 0 and 2;

R₅₁ and R₅₂ are independently selected from substituted or unsubstituted C₁-C₁₂ alkylidene groups;

R₆₁, R₆₂, and R₆₃ are each independently selected from a bond, substituted or unsubstituted C₁-C₁₂ alkylidene groups, or substituted or unsubstituted C₁-C₁₂ alkyleneoxy groups;

R₇₁ is selected from a bond, substituted or unsubstituted C₁-C₁₂ alkylidene groups, substituted or unsubstituted C₁-C₁₂ alkenylene groups, substituted or unsubstituted C₆-C₂₆ arylene groups, or substituted or unsubstituted C₂-C₁₂ heterocyclylene groups; and

when at least one of R₄₁, R₅₁, R₅₂, R₆₁, R₆₂, R₆₃, or R₇₁ is substituted, a substituent group is halogen.

According to an embodiment of this application, the third additive includes at least one of the following compounds: malononitrile, butanedinitrile, glutaronitrile, adiponitrile, heptanedinitrile, octanedinitrile, sebaconitrile, 3,3′-oxydipropionitrile, hex-2-enedinitrile, fumaronitrile, 2-pentenedirile, methylglutaronitrile, 4-cyanopimelonitrile, (Z)-but-2-enedinitrile, 2,2,3,3-tetrafluorosuccinonitrile, ethylene glycol bis(propionitrile) ether, 1,3,5-pentanetricarbonitrile, 1,3,6-hexanetricarbonitrile, 1,2,6-hexanetricarbonitrile, 1,2,3-tris(2-cyanooxy)propane, 1,1,3,3-propanetetracarbonitrile

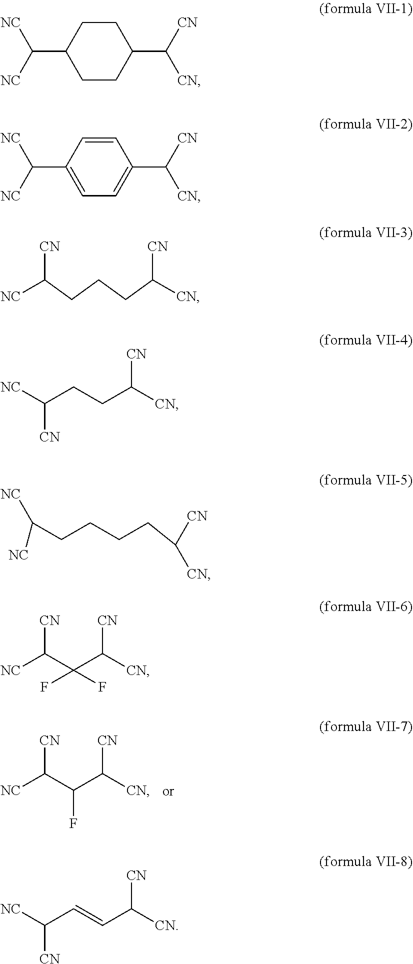

Adding the third additive on the basis of the compound represented by formula (I) can further improve the high-temperature cycling performance of the electrochemical apparatuses under high voltage conditions and further reduce the cycling resistance growth rate of the electrochemical apparatuses.

According to an embodiment of this application, based on a total weight of the electrolyte, a percentage of the third additive is 0.1 wt % to 12 wt %. In some embodiments, based on the total weight of the electrolyte, a percentage of the third additive is 0.5 wt % to 10 wt %. In some embodiments, based on the total weight of the electrolyte, a percentage of the third additive is 1 wt % to 8 wt %. In some embodiments, based on the total weight of the electrolyte, a percentage of the third additive is 2 wt % to 6 wt %. In some embodiments, based on the total weight of the electrolyte, a percentage of the third additive is 3 wt % to 5 wt %. In some embodiments, based on the total weight of the electrolyte, a percentage of the third additive is 0.1 wt %, 0.5 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, 10 wt %, 10.5 wt %, 11 wt %, 11.5 wt %, or 12 wt %, or falls within a range defined by any two of the foregoing values. Percentage of the third additive in the electrolyte being within the foregoing range helps further improve the high-temperature cycling performance of the electrochemical apparatuses under high voltage conditions and further reduce the cycling resistance growth rate of the electrochemical apparatuses.

According to an embodiment of this application, based on the total weight of the electrolyte, a percentage of the compound having two nitrile groups is x wt %, and a percentage of the compound having three or more nitrile groups is y wt %, where x−y≥0. In some embodiments, x and y satisfy x−y≥0.1 In some embodiments, x and y satisfy x−y≥1. In some embodiments, x and y satisfy x−y≥5. In some embodiments, x and y satisfy x−y≥8. In some embodiments, x and y satisfy x−y≥10. When the percentage x of the compound having two nitrile groups and the percentage y of the compound having three or more nitrile groups in the third additive satisfy the above relationship, the high-temperature cycling performance of the electrochemical apparatuses under high voltage conditions can be further improved, and the cycling resistance growth rate of the electrochemical apparatuses can be further reduced.

According to an embodiment of this application, the electrolyte further includes a fourth additive, where the fourth additive includes at least one of LiCH₃SO₃, LiCF₃SO₃, LiN(SO₂CF₃)₂, LiC(SO₂CF₃)₃, LiBOB, or LiDFOB.

The fourth additive is a lithium salt additive, where negative ions in the lithium salt are reduced before a solvent at a negative electrode, and oxidized before the solvent at a positive electrode, and a stable inorganic layer is formed to suppress consumption of the solvent at high potentials. Adding the fourth additive on the basis of the compound represented by formula (I) can further improve the high-temperature cycling performance of the electrochemical apparatuses under high voltage conditions and further reduce the cycling resistance growth rate of the electrochemical apparatuses.

According to an embodiment of this application, based on a total weight of the electrolyte, a percentage of the fourth additive is 0.05 wt % to 2 wt %. In some embodiments, based on the total weight of the electrolyte, a percentage of the fourth additive is 0.1 wt % to 1.5 wt %. In some embodiments, based on the total weight of the electrolyte, a percentage of the fourth additive is 0.5 wt % to 1 wt %. In some embodiments, based on the total weight of the electrolyte, a percentage of the fourth additive is 0.05 wt %, 0.1 wt %, 0.3 wt %, 0.5 wt %, 0.8 wt %, 1 wt %, 1.2 wt %, 1.5 wt %, 1.8 wt %, or 2 wt %, or falls within a range defined by any two of the foregoing values. Percentage of the fourth additive in the electrolyte being within the foregoing range helps further improve the high-temperature cycling performance of the electrochemical apparatuses under high voltage conditions and further reduce the cycling resistance growth rate of the electrochemical apparatuses.

According to an embodiment of this application, the electrolyte further includes lithium hexafluorophosphate (LiPF₆). In some embodiments, concentration of the lithium hexafluorophosphate is 0.6 M to 2 M. In some embodiments, concentration of the lithium hexafluorophosphate is 0.8 M to 1.2 M.

The electrolyte according to this application may be prepared by using any known method. In some embodiments, the electrolyte according to this application may be prepared by mixing all components.

Positive Electrode

The positive electrode includes a positive electrode current collector and a positive electrode active material layer disposed on one or two surfaces of the positive electrode current collector.

According to an embodiment of this application, the positive electrode active material contains first particles and second particles, and an average particle size of the first particles is greater than an average particle size of the second particles. Small particles of the positive electrode active material facilitate lithium-ion transmission, and large particles of the positive electrode active material maintain stability of particle structures at high potentials. A combination of two particles with different particle sizes can further improve the high-temperature cycling performance of the electrochemical apparatuses under high voltage conditions and further reduce the cycling resistance growth rate of the electrochemical apparatuses.

According to an embodiment of this application, an average particle size of the first particles or an average particle size of the second particles ranges from 5 μm to 20 μm. In some embodiments, an average particle size of the first particles or an average particle size of the second particles ranges from 8 μm to 18 μm. In some embodiments, an average particle size of the first particles or an average particle size of the second particles ranges from 10 μm to 15 μm. In some embodiments, an average particle size of the first particles or an average particle size of the second particles is 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm, or falls within a range defined by any two of the foregoing values.

According to an embodiment of this application, the first particle and the second particle have the same or different chemical compositions.

According to an embodiment of this application, the second particles contain element aluminum, and based on a total weight of the positive electrode active material, a percentage of element aluminum is 0.001 wt % to 1 wt %. In some embodiments, based on a total weight of the positive electrode active material, a percentage of element aluminum is 0.005 wt % to 0.8 wt %. In some embodiments, based on a total weight of the positive electrode active material, a percentage of element aluminum is 0.01 wt % to 0.5 wt %. In some embodiments, based on a total weight of the positive electrode active material, a percentage of element aluminum is 0.05 wt % to 0.3 wt %. In some embodiments, based on a total weight of the positive electrode active material, a percentage of element aluminum is 0.1 wt % to 0.2 wt %. In some embodiments, based on a total weight of the positive electrode active material, a percentage of element aluminum is 0.001 wt %, 0.005 wt %, 0.008 wt %, 0.01 wt %, 0.05 wt %, 0.08 wt %, 0.1 wt %, 0.3 wt %, 0.5 wt %, 0.8 wt %, or 1 wt %, or falls within a range defined by any two of the foregoing values. Percentage of element aluminum in the second particles being within the foregoing range helps further improve the high-temperature cycling performance of the electrochemical apparatuses under high voltage conditions and further reduce the cycling resistance growth rate of the electrochemical apparatuses.

According to an embodiment of this application, the positive electrode active material includes LiₐM¹_{b}M²_{c}M³_{d}O₂, where:

M¹ is selected from at least one of cobalt, nickel, or manganese;

M² is selected from at least one of magnesium, aluminum, or titanium;

M³ is selected from at least one of boron, chromium, iron, copper, zinc, niobium, molybdenum, tantalum, tin, sodium, potassium, barium, strontium, or calcium;

0.9≤a≤1.2;

0.80≤b≤1.2;

0.00001≤c≤0.2; and

0≤d≤0.002.

According to an embodiment of this application, the positive electrode active material includes, but is not limited to LiCoO₂, LiCo_{0.995}Mg_{0.002}Al_{0.003}O₂, LiCo_{0.993}Mg_{0.001}Ti_{0.001}Al_{0.005}O₂, LiCo_{0.994}Mg_{0.0025}Ti_{0.0005}Al_{0.003}O₂, LiCo_{0.988}Mg_{0.001}Ti_{0.001}Al_{0.01}O₂, LiCo_{0.898}Mg_{0.001}Ti_{0.001}Al_{0.1}O₂, LiCo_{0.948}Mg_{0.001}Ti_{0.001}Al_{0.5}O₂, LiCo_{0.987}Mg_{0.001}Ti_{0.001}Al_{0.01}Zr_{0.001}O₂, or LiNi_{0.497}Co_{0.2}Mn_{0.3}Al_{0.001}Zr_{0.002}O₂.

In some embodiments, the positive electrode active material may have a coating layer on a surface thereof. In some embodiments, the coating layer includes at least one of oxides of a coating element, hydroxides of a coating element, oxyhydroxide of a coating element, oxycarbonate (oxycarbonate) of a coating element, or hydroxycarbonate (hydroxycarbonate) of a coating element. The coating element contained in the coating layer may include Mg, Al, Co, K, Na, Ca, Si, Ti, V, Sn, Ge, Ga, B, As, or Zr, or a combination thereof. The compound used for the coating layer may be amorphous or crystalline. The coating layer can be applied by using any method as long as the method does not adversely affect performance of the positive electrode active material. A method for applying the coating layer may include any coating method well known to a person of ordinary skill in the art, such as spraying or dipping.

In some embodiments, the positive electrode active material layer further includes a binder. The binder can enhance bonding between particles of the positive electrode active material, and bonding between the positive electrode active material and the positive electrode current collector. In some embodiments, the binder includes, but is not limited to: polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly(1,1-difluoroethylene), polyethylene, polypropylene, styrene-butadiene rubber, acrylic styrene-butadiene rubber, epoxy resin, nylon, or the like.

In some embodiments, the positive electrode active material layer further includes a conductive material, thereby imparting conductivity to the electrode. The conductive material may include any conductive material as long as such conductive material causes no chemical change. Non-limiting examples of the conductive material include a carbon-based material (for example, natural graphite, artificial graphite, carbon black, acetylene black, Ketjen black, and carbon fiber), a metal-based material (for example, metal powder, and metal fiber, including copper, nickel, aluminum, and silver), a conductive polymer (for example, a polyphenylene derivative), and a mixture thereof.

In some embodiments, the positive electrode current collector may include but is not limited to aluminum (Al).

Negative Electrode

The negative electrode includes a negative electrode current collector and a negative electrode active material layer disposed on one or two surfaces of the negative electrode current collector. The specific types of the negative electrode active material are not subject to specific restrictions, and can be selected according to requirements.

According to some embodiments, the negative electrode current collector may be selected from copper foil, nickel foil, stainless steel foil, titanium foil, nickel foam, copper foam, a polymer substrate coated with conductive metal, or any combination thereof.

In some embodiments, the negative electrode active material is selected from one or more of natural graphite, artificial graphite, mesocarbon microbeads (MCMB for short), hard carbon, soft carbon, silicon, silicon-carbon composite, Li—Sn alloy, Li—Sn—O alloy, Sn, SnO, SnO₂, spinel-structure lithiated TiO₂—Li₄Ti₅O₁₂, or Li—Al alloy. Non-limiting examples of the carbon material include crystalline carbon, amorphous carbon, and a mixture thereof. The crystalline carbon may be amorphous, plate-shaped, flake-shaped, spherical or fiber-shaped natural graphite or artificial graphite. The amorphous carbon may be soft carbon, hard carbon, a mesophase pitch carbonization product, burnt coke, or the like.

In some embodiments, the negative electrode active material layer includes a binder. The binder improves bonding between particles of the negative active material, and bonding between the negative active material and the current collector. Non-limiting examples of the binder include polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly(1,1-difluoroethylene), polyethylene, polypropylene, styrene-butadiene rubber, acrylic styrene-butadiene rubber, epoxy resin, nylon, and the like.

In some embodiments, the negative electrode active material includes a conductive material, thereby imparting conductivity to the electrode. The conductive material may include any conductive material as long as such conductive material causes no chemical change. Non-limiting examples of the conductive material include a carbon-based material (for example, natural graphite, artificial graphite, carbon black, acetylene black, Ketjen black, and carbon fiber), a metal-based material (for example, metal powder, and metal fiber, including copper, nickel, aluminum, and silver), a conductive polymer (for example, a polyphenylene derivative), and a mixture thereof.

Separator

In some embodiments, a separator is provided between the positive electrode and the negative electrode to prevent a short circuit. The separator is not particularly limited to any material or shape, and may be based on any technology disclosed in the prior art. In some embodiments, the separator includes a polymer or an inorganic substance formed by a material stable to the electrolyte of this application.

In some embodiments, the separator includes a substrate layer. In some embodiments, the substrate layer is a non-woven fabric, membrane, or composite membrane of a porous structure. In some embodiments, a material of the substrate layer is selected from at least one of polyethylene, polypropylene, polyethylene terephthalate, or polyimide. In some embodiments, a material of the substrate layer is selected from a polypropylene porous membrane, a polyethylene porous membrane, a polypropylene non-woven fabric, a polyethylene non-woven fabric, or a polypropylene-polyethylene-polypropylene porous composite membrane.

In some embodiments, at least one surface of the substrate layer is provided with a surface treatment layer. In some embodiments, the surface treatment layer may be a polymer layer, an inorganic substance layer, or a layer formed by mixing a polymer and an inorganic substance. In some embodiments, the polymer layer includes a polymer, and a material of the polymer is selected from at least one of polyamide, polyacrylonitrile, an acrylate polymer, polyacrylic acid, polyacrylate, polyvinylpyrrolidone, polyvinyl ether, polyvinylidene fluoride, or poly(vinylidene fluoride-hexafluoropropylene).

In some embodiments, the inorganic substance layer includes inorganic particles and a binder. In some embodiments, the inorganic particles are selected from one or a combination of aluminum oxide, silicon oxide, magnesium oxide, titanium oxide, hafnium oxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate. In some embodiments, the binder is selected from one or a combination of polyvinylidene fluoride, vinylidene fluoride-hexafluoropropylene copolymer, polyamide, polyacrylonitrile, polyacrylic ester, polyacrylic acid, polyacrylate, polyvinylpyrrolidone, polyvinyl ether, polymethyl methacrylate, polytetrafluoroethylene, or polyhexafluoropropylene.

Electrochemical Apparatus

The electrochemical apparatus according to this application includes any apparatus in which an electrochemical reaction takes place. Specific examples of the apparatus include all types of primary batteries, secondary batteries, fuel batteries, solar batteries, or capacitors. Especially, the electrochemical apparatus is a lithium secondary battery, including a lithium metal secondary battery, a lithium-ion secondary battery, a lithium polymer secondary battery, or a lithium-ion polymer secondary battery.

Electronic Apparatus

This application also provides an electronic apparatus, including the electrochemical apparatus according to this application.

The electrochemical apparatus according to this application is not particularly limited to any purpose, and may be used for any known electronic apparatus in the prior art. In some embodiments, the electrochemical apparatus of this application may be used without limitation in notebook computers, pen-input computers, mobile computers, electronic book players, portable telephones, portable fax machines, portable copiers, portable printers, stereo headsets, video recorders, liquid crystal display televisions, portable cleaners, portable CD players, mini-disc players, transceivers, electronic notebooks, calculators, storage cards, portable recorders, radios, backup power sources, motors, automobiles, motorcycles, motor bicycles, bicycles, lighting appliances, toys, game machines, clocks, electric tools, flash lamps, cameras, large household batteries, lithium-ion capacitors, and the like.

The following uses a lithium-ion battery as an example and describes preparation of a lithium-ion battery with reference to specific examples. A person skilled in the art understands that the preparation method described in this application is only an example, and that all other suitable preparation methods fall within the scope of this application.

### Examples

The following describes performance evaluation performed based on examples and comparative examples of the lithium-ion battery in this application.

I. Preparation of Lithium-Ion Battery

1. Preparation of Positive Electrode

(1) The Positive Electrode Used in all Examples and Comparative Examples in Table 1 to Table 6 were Prepared by Using the Following Method:

Purchased CoCl₂ and AlCl₃ were prepared into aqueous solutions, and the aqueous solutions were mixed at a molar ratio of 1:k (0≤k≤0.01088221) of the active substance, and an NH₃HCO₃ solution was added to adjust the pH value of the mixture to about 10.5 so that a precipitant is obtained. The obtained precipitant was calcined for 5 hours at 400° C. to obtain Co₃O₄ containing element Al. The obtained Co₃O₄ containing element Al and Li₂CO₃ were mixed uniformly at a molar ratio of 2:3.15, and the resulting mixture was calcined for 8 hours at 1000° C. to obtain LiCoO₂. The obtained LiCoO₂ was added to Al₂O₃ (with a molar ratio of 1:[(0.01088221−k)/2]) and mixed uniformly. The resulting mixture was sintered at 800° C. for 8 hours, and lithium cobalt oxide containing element Al and having an average particle size of 12 μm was selected to obtain a positive electrode active material. Unless otherwise specified, in the examples and comparative examples listed in Table 1 to Table 6, based on a total weight of the positive electrode active material, a percentage of element Al is 0.003 wt %.

The prepared positive electrode active material, acetylene black, and polyvinylidene fluoride (PVDF) were dissolved in an N-methylpyrrolidone (NMP) solvent system at a weight ratio of 96:2:2, and fully stirred and mixed to obtain a positive electrode slurry. The positive electrode slurry was uniformly applied onto a positive electrode collector aluminum foil, followed by drying and cold pressing, to obtain a positive electrode active material layer. After cutting and tab welding, a positive electrode was obtained.

(2) The Positive Electrode Used in all Examples and Comparative Examples in Table 7 were Prepared by Using the Following Method:

Transition metal such as Al, Mg, Ti, Zr, or Ni was added to lithium cobalt oxide using a similar method as above to prepare the positive electrode active materials used in all examples and comparative examples in Table 7.

2. Preparation of Negative Electrode

Artificial graphite, sodium carboxymethyl cellulose (CMC), and styrene-butadiene rubber (SBR) were dissolved in a deionized water solvent system at a weight ratio of 97:1:2 and stirred and mixed to obtain a negative electrode slurry. The negative electrode slurry was uniformly applied onto a negative electrode current collector copper foil, followed by drying, cold pressing, cutting, slitting, and vacuum drying, to obtain a negative electrode.

3. Preparation of Electrolyte

In a dry argon atmosphere glove box, ethylene carbonate (EC), propylene carbonate (PC), and propyl propionate (PP) were mixed uniformly at a mass ratio of 1:3:6. Then, the components (the percentage shown is the mass percentage calculated based on a total weight of the electrolyte) shown in examples and comparative examples in the following table were added into the mixture, dissolved, and fully stirred, and then a lithium salt LiPF₆ was added and uniformly mixed to obtain an electrolyte. Concentration of LiPF₆ in the electrolyte was 1 mol/L.

4. Preparation of Separator

A mixture of boehmite and polyacrylic ester was dissolved in deionized water to form a coating slurry. Then, the coating slurry was uniformly applied onto two surfaces of the porous substrate by using the micro-gravure coating method, and dried to obtain the separator.

5. Preparation of Lithium-Ion Battery

The positive electrode, the separator, and the negative electrode were stacked in order, so that the separator was placed between the positive electrode and the negative electrode. Then the stack was wound, welded with tabs, and then placed in an outer packaging foil. Then the foregoing prepared electrolyte was injected, followed by processes such as vacuum packaging, standing, formation, and shaping, to obtain a lithium-ion battery.

II. Test Method

(1) Test Method for High-Temperature Cycling Performance and Cycling Resistance Growth Rate of Lithium-Ion Batteries

The lithium-ion battery prepared was placed in a 25° C. thermostat and standing for 1 hour, charged to 4.45V at a constant current of 1 C, charged at a constant voltage to a current of 0.025 C, standing for 120 minutes, then charged at a current of 0.1 C for 10 seconds, and charged at a direct current of 1 C for 360 seconds. Direct current resistance of the lithium-ion battery at 80% state of charge (SOC) before high-temperature cycling is calculated according to the following formula:

$$Direct current resistance = \frac{0.1 C end - of - discharge voltage - 1 C end - of - discharge voltage}{0.1 C end - of - discharge voltage - 1 C end - of - discharge voltage}$$

Then, the lithium-ion battery was placed in a 45° C. thermostat and standing for 30 minutes so that the lithium-ion battery reached a constant temperature. The lithium-ion battery that had reached the constant temperature was charged at a constant current of 1 C to a voltage of 4.45V, then charged at a constant voltage of 4.45V to a current of 0.025 C, and then discharged at a constant current of 1 C to a voltage of 3.0V. This was one charge-discharge cycle. An initial discharge capacity was recorded. The test was stopped after 400 charge-discharge cycles in the foregoing manner, and a discharge capacity at that point was recorded. Capacity retention rate and thickness growth rate after high-temperature cycling were calculated according to the following formula:

Capacity retention rate after high-temperature cycling=discharge capacity after cycling/first-cycle discharge capacity×100%

Subsequently, the lithium-ion battery after high-temperature cycling was placed in a 25° C. thermostat and standing for 1 hour, charged to 4.45V at a constant current of 1 C, charged at a constant voltage to a current of 0.025 C, standing for 120 minutes, charged at a current of 0.1 C for 10 seconds, and charged at a direct current of 1 C for 360 seconds. The direct current resistance of the lithium-ion battery in 80% state of charge (SOC) after high-temperature cycling was calculated according to the foregoing formula: The cycling resistance growth rate of the lithium-ion battery was calculated according to the following formula:

Cycling resistance growth rate=(direct current resistance of lithium-ion battery after high-temperature cycling−direct current resistance of lithium-ion battery before high-temperature cycling)/direct current resistance of lithium-ion battery before high-temperature cycling×100%.

2. Test Method for Average Particle Size of Positive Electrode Active Material

An average particle size of a positive electrode active material was measured according to the MasterSizer 2000 laser diffraction method.

III. Test Results

Table 1 shows the effect of the compound represented by formula (I) on the high-temperature cycling performance and cycling resistance growth rate of the lithium-ion batteries.

TABLE 1

| | | | Capacity retention | Cycling |
|---|---|---|---|---|
| | | Percentage | rate after high- | resistance |
| | Compound | (wt %) | temperature cycling | growth rate |
| Comparative | / | / | 50.36% | 301% |
| Example 1 | | | | |
| Comparative | Imidazole | 0.5 | 51.23% | 293% |
| Example 2 | | | | |
| Comparative | Triazole | 0.5 | 53.21% | 283% |
| Example 3 | | | | |
| Comparative | Carbonyl | 0.5 | 54.65% | 270% |
| Example 4 | diimidazole | | | |
| Example 1 | formula | 0.5 | 56.11% | 216% |
| | (Ia-1) | | | |
| Example 2 | formula | 0.5 | 55.75% | 234% |
| | (Ia-2) | | | |
| Example 3 | formula | 0.5 | 56.55% | 222% |
| | (Ia-3) | | | |
| Example 4 | formula | 0.5 | 57.02% | 227% |
| | (Ia-4) | | | |
| Example 5 | formula | 0.5 | 55.61% | 210% |
| | (Ia-5) | | | |
| Example 6 | formula | 0.5 | 55.12% | 224% |
| | (Ib-2) | | | |
| Example 7 | formula | 0.5 | 58.10% | 210% |
| | (Ic-1) | | | |
| Example 8 | formula | 0.5 | 56.97% | 219% |
| | (Id-1) | | | |
| Comparative | Carbonyl | 7 | 49.82% | 294% |
| Example 5 | diimidazole | | | |
| Example 9 | formula | 7 | 50.15% | 242% |
| | (Ia-1) | | | |

“/” indicates that such substance is not added.

Results show that compared with imidazole, triazole, and carbonyl diimidazole, carbonyl triazole compound and thiocarbonyltriazole compound (that is, a compound represented by formula (I)) can significantly improve the high-temperature cycling performance and significantly reduce the cycling resistance growth rate of lithium-ion batteries.

Table 2 shows the effect of the percentage of the compound represented by formula (I) on the high-temperature cycling performance and cycling resistance growth rate of the lithium-ion batteries.

TABLE 2

| | Compound | | Capacity retention | Cycling |
|---|---|---|---|---|
| | represented by | Percentage | rate after high- | resistance |
| | formula (I) | (wt %) | temperature cycling | growth rate |
| Example 10 | formula (Ia-1) | 0.01 | 50.42% | 296% |
| Example 11 | formula (Ia-1) | 0.02 | 51.10% | 245% |
| Example 12 | formula (Ia-1) | 0.05 | 51.57% | 228% |
| Example 1 | formula (Ia-1) | 0.5 | 56.11% | 216% |
| Example 13 | formula (Ia-1) | 1 | 56.52% | 214% |
| Example 14 | formula (Ia-1) | 3 | 55.57% | 225% |
| Example 15 | formula (Ia-1) | 6 | 53.07% | 226% |
| Example 9 | formula (Ia-1) | 7 | 50.15% | 242% |
| Example 16 | formula (Ia-4) | 0.02 | 51.49% | 237% |
| Example 17 | formula (Ia-4) | 0.05 | 52.48% | 220% |
| Example 4 | formula (Ia-4) | 0.5 | 57.02% | 208% |
| Example 18 | formula (Ia-4) | 1 | 57.31% | 206% |
| Example 19 | formula (Ia-4) | 3 | 56.64% | 217% |
| Example 20 | formula (Ia-4) | 6 | 53.56% | 218% |
| Example 7 | formula (Ic-1) | 0.5 | 58.10% | 210% |
| Example 21 | formula (Ic-1) | 1 | 58.78% | 200% |
| Example 8 | formula (Id-1) | 0.5 | 56.97% | 219% |
| Example 22 | formula (Id-1) | 1 | 57.97% | 214% |

“/” indicates that such substance is not added.

The results show that the percentage of the compound represented by formula (I) in the electrolyte being within a range of 0.02 wt % to 6 wt % helps further improve the high-temperature cycling performance and reduce the cycling resistance growth rate of the lithium-ion batteries. The percentage of the compound represented by formula (I) in the electrolyte being within a range of 0.5 wt % to 3 wt % significantly improves the high-temperature cycling performance and reduces the cycling resistance growth rate of the lithium-ion batteries.

Table 3 shows the effect of the first additive and the proportional relationship between the first additive and the compound represented by formula (I) on the high-temperature cycling performance and cycling resistance growth rate of the lithium-ion batteries.

TABLE 3

| | | | | | | Capacity | |
|---|---|---|---|---|---|---|---|
| | | | | | | retention | |
| | Compound represented | | | | | rate after | |
| | by formula (I) | | First additive | | | high- | Cycling |
| | | Percentage n | | Percentage m | | temperature | resistance |
| | Compound | (wt %) | Compound | (wt %) | m − n | cycling | growth rate |
| Comparative | / | 0 | FEC | 8 | 8 | 57.00% | 191% |
| Example 6 | | | | | | | |
| Example 7 | formula | 0.5 | / | 0 | −0.5 | 58.10% | 210% |
| | (Ic-1) | | | | | | |
| Example 23 | formula | 0.5 | FEC | 0.5 | 0 | 58.18% | 206% |
| | (Ic-1) | | | | | | |
| Example 24 | formula | 0.5 | FEC | 2 | 1.5 | 63.33% | 186% |
| | (Ic-1) | | | | | | |
| Example 25 | formula | 0.5 | FEC | 4 | 3.5 | 69.73% | 172% |
| | (Ic-1) | | | | | | |
| Example 26 | formula | 0.5 | FEC | 5 | 4.5 | 70.33% | 161% |
| | (Ic-1) | | | | | | |
| Example 27 | formula | 0.5 | FEC | 8 | 7.5 | 71.80% | 145% |
| | (Ic-1) | | | | | | |
| Example 28 | formula | 0.5 | FEC | 15 | 14.5 | 70.65% | 151% |
| | (Ic-1) | | | | | | |
| Example 29 | formula | 0.5 | FEC | 20 | 19.5 | 56.25% | 211% |
| | (Ic-1) | | | | | | |
| Example 30 | formula | 0.5 | FEC | 21 | 20.5 | 56.91% | 219% |
| | (Ic-1) | | | | | | |
| Example 31 | formula | 1 | / | 0 | −1 | 58.78% | 200% |
| | (Ic-1) | | | | | | |
| Example 32 | formula | 1 | FEC | 0.5 | −0.5 | 59.64% | 189% |
| | (Ic-1) | | | | | | |
| Example 33 | formula | 1 | FEC | 2 | 1 | 66.27% | 168% |
| | (Ic-1) | | | | | | |
| Example 34 | formula | 1 | FEC | 5 | 4 | 70.09% | 156% |
| | (Ic-1) | | | | | | |
| Example 35 | formula | 1 | FEC | 10 | 9 | 65.85% | 152% |
| | (Ic-1) | | | | | | |
| Example 36 | formula | 1 | FEC | 15 | 14 | 57.76% | 168% |
| | (Ic-1) | | | | | | |
| Example 37 | formula | 3 | FEC | 0.5 | −2.5 | 56.49% | 209% |
| | (Ic-1) | | | | | | |
| Example 38 | formula | 3 | FEC | 2 | −1 | 59.95% | 172% |
| | (Ic-1) | | | | | | |
| Example 39 | formula | 3 | FEC | 5 | 2 | 62.21% | 164% |
| | (Ic-1) | | | | | | |
| Example 40 | formula | 1 | FEC | 7 | 7 | 71.87% | 144% |
| | (Ic-1) | | VC | 1 | | | |
| Example 41 | formula | 0.5 | FEC | 8 | 7 | 71.90% | 140% |
| | (Ia-4) | 0.5 | | | | | |
| | formula | | | | | | |
| | (Ic-1) | | | | | | |

“/” indicates that such substance is not added.

Results show that when the electrolyte contains the first additive (at least one of fluoroethylene carbonate (FEC) or vinylene carbonate (VC)) and the percentage m of the first additive and the percentage n of the compound represented by formula (I) satisfy −1≤5 m−n≤18, the lithium-ion battery has significantly improved high-temperature cycling performance and significantly reduced cycling resistance growth rate.

Table 4 shows the effect of the second additive on the high-temperature cycling performance and cycling resistance growth rate of the lithium-ion batteries. Examples 42 to 51 in Table 4 contain a same compound as that represented by formula (I) in Example 7, that is, the compound represented by formula (Ic-1) with a percentage of 0.5 wt %.

TABLE 4

| | | | | | Capacity | |
|---|---|---|---|---|---|---|
| | | | | | retention | |
| | | | | | rate after | |
| | First additive | | Second additive | | high- | Cycling |
| | | Percentage | | Percentage | temperature | resistance |
| | Compound | (wt %) | Compound | (wt %) | cycling | growth rate |
| Example 7 | / | / | / | / | 58.10% | 210% |
| Example 27 | FEC | 8 | / | / | 71.80% | 145% |
| Example 42 | FEC | 8 | formula III-6 | 0.5 | 72.28% | 144% |
| Example 43 | FEC | 8 | formula III-6 | 3 | 78.39% | 140% |
| Example 44 | FEC | 8 | formula III-6 | 6 | 72.35% | 159% |
| Example 45 | FEC | 8 | formula III-6 | 10 | 68.56% | 228% |
| Example 46 | FEC | 8 | formula III-6 | 12 | 53.71% | 254% |
| Example 47 | FEC | 8 | formula II-6 | 3 | 75.83% | 140% |
| Example 48 | FEC | 8 | formula II-6 | 6 | 73.52% | 150% |
| Example 49 | FEC | 8 | formula III-6 | 1 | 76.34% | 137% |
| | | | formula II-6 | 2 | | |
| Example 50 | FEC | 8 | formula III-6 | 2 | 77.42% | 138% |
| | | | formula II-6 | 1 | | |
| Example 51 | / | / | formula III-6 | 3 | 59.50% | 174% |

“/” indicates that such substance is not added.

The results show that the percentage of the second additive in the electrolyte being 0.05 wt % to 10 wt % helps further improve the high-temperature cycling performance of the lithium-ion batteries and reduce the cycling resistance growth rate of the lithium-ion batteries. When the percentage of the second additive in the electrolyte is 0.5 wt % to 6 wt %, the lithium-ion batteries have significantly better high-temperature cycling performance and lower cycling resistance growth rate. In addition, use of a plurality of second additives in combination can further improve the high-temperature cycling performance and reduce the cycling resistance growth rate of the lithium-ion batteries.

Table 5 shows the effect of the third additive on the high-temperature cycling performance and cycling resistance growth rate of the lithium-ion batteries. Examples 52 to 77 in Table 5 contain a same compound as that represented by formula (I) in Example 7, that is, the compound represented by formula (Ic-1) with a percentage of 0.5 wt %.

TABLE 5

| | | | | | | | | | | Capacity | |
|---|---|---|---|---|---|---|---|---|---|---|---|
| | | | | | | | | | | retention | |
| | | | | | Third additive | | | | | rate after | |
| | First additive | | Second additive | | | Per- | Compound | Per- | | high- | Cycling |
| | | Per- | | Per- | Compound | centage | having three | centage | | temper- | resistance |
| | Com- | centage | Com- | centage | having two | x | or more | y | | ature | growth |
| | pound | (wt %) | pound | (wt %) | nitrile groups | (wt %) | nitrile groups | (wt %) | X − y | cycling | rate |
| Example 7 | / | / | / | / | / | 0 | / | 0 | 0 | 58.10% | 210% |
| Example 52 | / | / | / | / | Butanedinitrile | 0.05 | / | 0 | 0.05 | 58.09% | 210% |
| Example 53 | / | / | / | / | Butanedinitrile | 0.1 | / | 0 | 0.1 | 58.75% | 206% |
| Example 54 | / | / | / | / | Butanedinitrile | 3 | / | 0 | 3 | 58.80% | 188% |
| Example 55 | / | / | / | / | Butanedinitrile | 5 | / | 0 | 5 | 59.00% | 182% |
| Example 56 | / | / | / | / | Butanedinitrile | 8 | / | 0 | 8 | 59.29% | 195% |
| Example 57 | / | / | / | / | Butanedinitrile | 12 | / | 0 | 12 | 58.85% | 208% |
| Example 58 | / | / | / | / | Butanedinitrile | 13 | / | 0 | 13 | 57.11% | 226% |
| Example 59 | / | / | / | / | Butanedinitrile | 3 | / | 0 | 4 | 58.99% | 185% |
| | | | | | Adiponitrile | 1 | | | | | |
| Example 60 | / | / | / | / | Butanedinitrile | 3 | / | 0 | 6 | 59.32% | 187% |
| | | | | | Adiponitrile | 3 | | | | | |
| Example 61 | / | / | / | / | Butanedinitrile | 3 | / | 0 | 8 | 59.51% | 191% |
| | | | | | Adiponitrile | 5 | | | | | |
| Example 62 | / | / | / | / | Butanedinitrile | 3 | / | 0 | 4 | 59.16% | 186% |
| | | | | | Ethylene glycol | 1 | / | 0 | | | |
| | | | | | bis(propionitrile) | | | | | | |
| | | | | | ether | | | | | | |
| Example 63 | / | / | / | / | Butanedinitrile | 3 | / | 0 | 6 | 59.50% | 193% |
| | | | | | Ethylene glycol | 3 | | | | | |
| | | | | | bis(propionitrile) | | | | | | |
| | | | | | ether | | | | | | |
| Example 64 | / | / | / | / | Butanedinitrile | 3 | / | 0 | 8 | 59.38% | 209% |
| | | | | | Ethylene glycol | 5 | | | | | |
| | | | | | bis(propionitrile) | | | | | | |
| | | | | | ether | | | | | | |
| Example 65 | / | / | / | / | Butanedinitrile | 3 | 1,3,6-hexane- | 1 | 2 | 59.25% | 184% |
| | | | | | | | tricarbonitrile | | | | |
| Example 66 | / | / | / | / | Butanedinitrile | 3 | 1,3,6-hexane- | 3 | 0 | 59.58% | 192% |
| | | | | | | | tricarbonitrile | | | | |
| Example 67 | / | / | / | / | Butanedinitrile | 3 | 1,3,6-hexane- | 5 | -2 | 59.16% | 207% |
| | | | | | | | tricarbonitrile | | | | |
| Example 68 | / | / | / | / | Butanedinitrile | 3 | 1,3,6-hexane- | 2 | 0 | 60.22% | 193% |
| | | | | | | | tricarbonitrile | | | | |
| | | | | | | | l,2,3-tris(2-cyano- | 1 | | | |
| | | | | | | | ethoxy)propane | | | | |
| Example 69 | / | / | / | / | Butanedinitrile | 3 | 1,3,6-hexane- | 2 | -2 | 59.79% | 206% |
| | | | | | | | tricarbonitrile | | | | |
| | | | | | | | l,2,3-tris(2-cyano- | 3 | | | |
| | | | | | | | ethoxy)propane | | | | |
| Example 70 | / | / | / | / | Adiponitrile | 3 | 1,3,6-hexane- | 2 | 0 | 59.90% | 191% |
| | | | | | | | tricarbonitrile | | | | |
| | | | | | | | l,2,3-tris(2-cyano- | 1 | | | |
| | | | | | | | ethoxy)propane | | | | |
| Example 71 | / | / | / | / | Adiponitrile | 3 | 1,3,6-hexane- | 2 | 2 | 59.51% | 193% |
| | | | | | Ethylene glycol | 1 | tricarbonitrile | | | | |
| | | | | | bis(propionitrile) | | | | | | |
| | | | | | ether | | | | | | |
| Example 72 | FEC | 8 | / | / | Butanedinitrile | 3 | 1,3,6-hexane- | 3 | 0 | 73.65% | 149% |
| | | | | | | | tricarbonitrile | | | | |
| Example 73 | FEC | 8 | / | / | Adiponitrile | 3 | 1,3,6-hexane- | 2 | 2 | 74.22% | 151% |
| | | | | | Ethylene glycol | 1 | tricarbonitrile | | | | |
| | | | | | bis(propionitrile) | | | | | | |
| | | | | | ether | | | | | | |
| Example 74 | / | / | formula | 3 | Butanedinitrile | 3 | 1,3,6-hexane- | 3 | 0 | 61.48% | 161% |
| | | | III-6 | | | | tricarbonitrile | | | | |
| Example 75 | / | / | formula | 3 | Adiponitrile | 3 | 1,3,6-hexane- | | | | |
| | | | III-6 | | Ethylene glycol | 1 | tricarbonitrile | 2 | 2 | 61.18% | 165% |
| | | | | | bis(propionitrile) | | | | | | |
| | | | | | ether | | | | | | |
| Example 76 | FEC | 8 | formula | 3 | Butanedinitrile | 3 | 1,3,6-hexane- | 3 | 0 | 80.10% | 143% |
| | | | III-6 | | | | tricarbonitrile | | | | |
| Example 77 | FEC | 8 | formula | 3 | Adiponitrile | 3 | 1,3,6-hexane- | 2 | 2 | 80.39% | 145% |
| | | | III-6 | | Ethylene glycol | 1 | tricarbonitrile | | | | |
| | | | | | bis(propionitrile) | | | | | | |
| | | | | | ether | | | | | | |

The results show that the percentage of the third additive in the electrolyte being 0.1 wt % to 12 wt % helps further improve the high-temperature cycling performance and reduce the cycling resistance growth rate of the lithium-ion batteries. When percentage x of the compound having two nitrile groups and percentage y of the compound having three or more nitrile groups in the third additive satisfy x−y≥0, the high-temperature cycling performance of the electrochemical apparatuses can be further improved, and the cycling resistance growth rate of the electrochemical apparatuses can be further reduced.

Table 6 shows the effect of the fourth additive on the high-temperature cycling performance and cycling resistance growth rate of the lithium-ion batteries. Examples 78 to 89 in Table 6 contain a same compound as that represented by formula (I) in Example 7, that is, the compound represented by formula (Ic-1) with a percentage of 0.5 wt %.

TABLE 6

| | | | | | | | | | Capacity | |
|---|---|---|---|---|---|---|---|---|---|---|
| | | | | | | | | | retention | |
| | | | | | | | | | rate after | Cycling |
| | First additive | | Second additive | | Third additive | | Fourth additive | | high- | resistance |
| | | Percentage | | Percentage | | Percentage | | Percentage | temperature | growth |
| | Compound | (wt %) | Compound | (wt %) | Compound | (wt %) | Compound | (wt %) | cycling | rate |
| Example 7 | / | / | / | / | / | / | / | / | 58.10% | 210% |
| Example 78 | / | / | / | / | / | / | LiBOB | 0.02 | 58.12% | 210% |
| Example 79 | / | / | / | / | / | / | LiBOB | 0.05 | 58.43% | 190% |
| Example 80 | / | / | / | / | / | / | LiBOB | 0.1 | 60.06% | 183% |
| Example 81 | / | / | / | / | / | / | LiBOB | 1 | 62.50% | 177% |
| Example 82 | / | / | / | / | / | / | LiBOB | 2 | 62.36% | 206% |
| Example 83 | / | / | / | / | / | / | LiBOB | 2.5 | 57.13% | 228% |
| Example 84 | / | / | / | / | / | / | LiDFOB | 1 | 61.51% | 182% |
| Example 85 | FEC | 8 | / | / | / | / | LiBOB | 1 | 69.36% | 150% |
| Example 86 | FEC | 8 | formula III-6 | 3 | / | / | LiBOB | 1 | 78.41% | 139% |
| Example 87 | FEC | 6 | formula III-6 | 5 | / | / | LiBOB | 1 | 76.96% | 153% |
| Example 88 | FEC | 8 | formula III-6 | 3 | Butanedinitrile | 3 | LiBOB | 1 | 79.05% | 138% |
| Example 89 | FEC | 8 | formula III-6 | 3 | Butanedinitrile | 3 | LiBOB | 1 | 80.15% | 134% |
| | | | | | 1,3,6-hexane- | 3 | | | | |
| | | | | | tricarbonitrile | | | | | |

The results show that the percentage of the fourth additive in the electrolyte being 0.05 wt % to 2 wt % helps further improve the high-temperature cycling performance and further reduce the cycling resistance growth rate of the lithium-ion batteries.

Table 7 shows the effect of the positive electrode active material on the high-temperature cycling performance and cycling resistance growth rate of the lithium-ion batteries. The electrolyte used in Examples 90 to 102 in Table 7 is the same as the electrolyte used in Example 89, and the weight ratios of the first particle to the second particle in Examples 90 to 102 are the same.

The results show that when the positive electrode active material contains two types of particles with different average particle sizes, the high-temperature cycling performance of the lithium-ion batteries can be further improved and the cycling resistance growth rate of the lithium-ion batteries can be further reduced. The two types of particles with different average particle sizes may have same or different chemical compositions, with essentially same effects achieved. When the particle with a smaller average particle size (that is, the second particle) contains element aluminum of 0.001 wt % to 1 wt %, the high-temperature cycling performance of the lithium-ion batteries can be further improved. When the particle with a smaller average particle size (that is, the second particle) contains element aluminum of 0.001 wt % to 0.1 wt %, the high-temperature cycling performance of the lithium-ion batteries can be further improved and the cycling resistance growth rate of the lithium-ion batteries can be further reduced.

TABLE 7

| | | | | | Capacity | |
|---|---|---|---|---|---|---|
| | First particle | | Second particle | | retention | |
| | | Average | | Average | rate after | Cycling |
| | | particle | | particle | high- | resistance |
| | | size | | size | temperature | growth |
| | Composition | (μm) | Composition | (μm) | cycling | rate |
| Example 90 | LiCo_{0.995}Ti_{0.002}Al_{0.003}O₂ | 12 | / | / | 80.15% | 134% |
| Example 91 | LiCo_{0.995}Ti_{0.002}Al_{0.003}O₂ | 12 | LiCo_{0.995}Ti_{0.002}Al_{0.003}O₂ | 5 | 80.63% | 133% |
| Example 92 | LiCo_{0.995}Ti_{0.002}Al_{0.003}O₂ | 15 | LiCo_{0.997}Ti_{0.002}Al_{0.001}O₂ | 5 | 80.23% | 134% |
| Example 93 | LiCo_{0.995}Ti_{0.002}Al_{0.003}O₂ | 15 | LiCo_{0.993}Mg_{0.001}Ti_{0.001}Al_{0.005}O₂ | 5 | 80.88% | 133% |
| Example 94 | LiCo_{0.994}Mg_{0.0025}Ti_{0.0005}Al_{0.003}O₂ | 15 | LiCo_{0.993}Mg_{0.001}Ti_{0.001}Al_{0.005}O₂ | 5 | 81.25% | 132% |
| Example 95 | LiCo_{0.994}Mg_{0.0025}Ti_{0.0005}Al_{0.003}O₂ | 15 | LiCo_{0.993}Mg_{0.001}Ti_{0.001}Al_{0.005}O₂ | 8 | 81.49% | 135% |
| Example 96 | LiCo_{0.994}Mg_{0.0025}Ti_{0.0005}Al_{0.003}O₂ | 18 | LiCo_{0.993}Mg_{0.001}Ti_{0.001}Al_{0.005}O₂ | 5 | 82.74% | 132% |
| Example 97 | LiCo_{0.994}Mg_{0.0025}Ti_{0.0005}Al_{0.003}O₂ | 18 | LiCo_{0.988}Mg_{0.001}Ti_{0.001}Al_{0.01}O₂ | 3 | 83.61% | 131% |
| Example 98 | LiCo_{0.994}Mg_{0.0025}Ti_{0.0005}Al_{0.003}O₂ | 18 | LiCo_{0.898}Mg_{0.001}Ti_{0.001}Al_{0.1}O₂ | 3 | 83.59% | 135% |
| Example 99 | LiCo_{0.994}Mg_{0.0025}Ti_{0.0005}Al_{0.003}O₂ | 18 | LiCo_{0.948}Mg_{0.001}Ti_{0.001}Al_{0.005}O₂ | 5 | 81.56% | 131% |
| Example 100 | LiCo_{0.994}Mg_{0.0025}Ti_{0.0005}Al_{0.003}O₂ | 18 | LiCo_{0.948}Mg_{0.001}Ti_{0.001}Al_{0.005}O₂ | 2 | 81.16% | 134% |
| Example 101 | LiCo_{0.994}Mg_{0.0025}Ti_{0.0005}Al_{0.003}O₂ | 18 | LiCo_{0.987}Mg_{0.001}Ti_{0.001}Al_{0.01}O₂ | 4 | 83.68% | 129% |
| Example 102 | LiNi_{0.497}Co_{0.2}Mn_{0.3}Zr_{0.001}Sr_{0.002}O₂ | 18 | LiCo_{0.987}Mg_{0.001}Ti_{0.001}Al_{0.01}O₂ | 5 | 85.47% | 125% |

In this specification, reference to “an embodiment”, “some embodiments”, “one embodiment”, “another example”, “an example”, “a specific example”, or “some examples” means that at least one embodiment or example in this application includes a specific feature, structure, material, or characteristic described in this embodiment or example. Therefore, descriptions in various places throughout this specification, such as “in some embodiments”, “in the embodiments”, “in an embodiment”, “in another example”, “in an example”, “in a specific example”, or “examples” do not necessarily refer to the same embodiment or example in this application. In addition, a specific feature, structure, material, or characteristic herein may be combined in any appropriate manner in one or more embodiments or examples.

Although illustrative embodiments have been demonstrated and described, a person skilled in the art should understand that the foregoing embodiments are not to be construed as limiting this application, and that the embodiments may be changed, replaced, and modified without departing from the spirit, principle, and scope of this application.

What is claimed is:

1. An electrolyte, comprising a compound represented by formula (I): 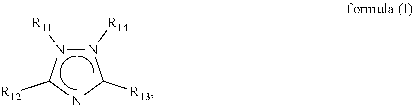
wherein,
R₁₁, R₁₂, R₁₃, and R₁₄ are each independently selected from a hydrogen atom, substituted or unsubstituted C₁-C₂₀ hydrocarbyl groups, or substituted or unsubstituted C₁-C₂₀ organic functional groups containing heteroatoms; and
at least one of R₁₁, R₁₂, R₁₃, or R₁₄ is 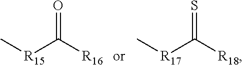
wherein:
R₁₅ and R₁₇ are each independently selected from a single bond, substituted or unsubstituted C₁-C₄ alkylidene groups, substituted or unsubstituted C₂-C₄ alkenylene groups, or substituted or unsubstituted C₆-C₁₀ arylene groups; and
R₁₆ and R₁₈ are each independently selected from substituted or unsubstituted C₁-C₁₀ hydrocarbyl groups or substituted or unsubstituted C₁-C₁₀ organic functional groups containing heteroatoms;
wherein the heteroatom is selected from at least one of oxygen, nitrogen, sulfur, phosphorus, silicon, or aluminum; and
when at least one of R₁, R₁₂, R₁₃, R₁₄, R₁₅, R₁₆, R₁₇, or R₁₈ is substituted, a substituent group is halogen or —CN.

2. The electrolyte according to claim 1, wherein the compound represented by formula (I) comprises at least one of compounds represented by formula (I-a) to formula (I-d): 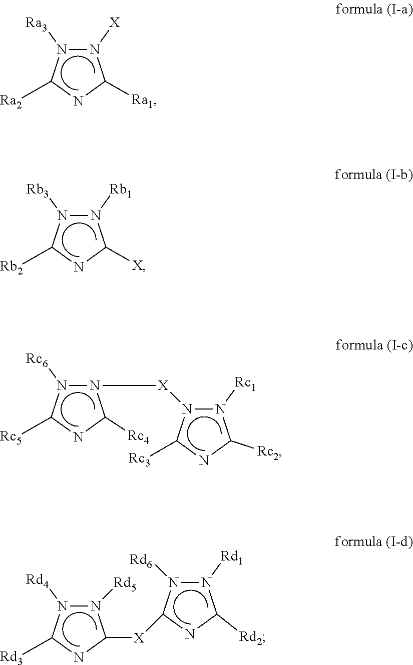
wherein,
X is 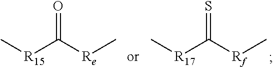
Ra₁, Ra₂, Ra₃, Rb₁, Rb₂, Rb₃, Rc₁, Rc₂, Rc₃, Rc₄, Rc₅, Rc₆, Rd₁, Rd₂, Rd₃, Rd₄, Rd₅, and Rd₆ are each independently selected from a hydrogen atom, substituted or unsubstituted C₁-C₂₀ alkyl groups, substituted or unsubstituted C₂-C₂₀ alkenyl groups, substituted or unsubstituted C₂-C₂₀ alkynyl groups, substituted or unsubstituted C₆-C₃₀ aryl groups, substituted or unsubstituted C₁-C₂₀ alkoxy groups, substituted or unsubstituted C₂-C₂₀ alkenyloxy groups, substituted or unsubstituted C₂-C₂₀ alkynyloxy groups, substituted or unsubstituted C₆-C₃₀ aryloxy groups, carboxyl group, ether group, carbonyloxy group, sulfhydryl group, cyan group, amido group, carbonamide group, substituted or unsubstituted C₁-C₁₆ siloxy groups, C₁-C₁₆ alumina alkyl groups, substituted or unsubstituted C₁-C₁₀ saturated cycloalkyl groups, substituted or unsubstituted furanyl groups, substituted or unsubstituted pyranyl groups, substituted or unsubstituted piperidinyl groups, substituted or unsubstituted piperazinyl groups, substituted or unsubstituted pyrrolyl groups, substituted or unsubstituted pyrazolyl groups, substituted or unsubstituted pyrazinyl groups, substituted or unsubstituted pyridazinyl groups, substituted or unsubstituted imidazolyl groups, substituted or unsubstituted triazolyl groups, substituted or unsubstituted thienyl groups, substituted or unsubstituted thiazolyl groups, or substituted or unsubstituted oxazolyl groups;
R₁₅, Rₑ, R₁₇, and R_{f} are each independently selected from a bond, substituted or unsubstituted C₁-C₄ alkylidene groups, substituted or unsubstituted C₂-C₄ alkenylene groups, or substituted or unsubstituted C₆-C₁₀ arylidene groups; and
when at least one of Ra₁, Ra₂, Ra₃, Rb₁, Rb₂, Rb₃, Rc₁, Rc₂, Rc₃, Rc₄, Rc₅, Rc₆, Rd₁, Rd₂, Rd₃, Rd₄, Rd₅, Rd₆, Rₑ, or R_{f} is substituted, a substituent group is halogen, C₁-C₆ alkyl groups, or —CN.

3. The electrolyte according to claim 1, wherein the compound represented by formula (I) comprises at least one of the following compounds:

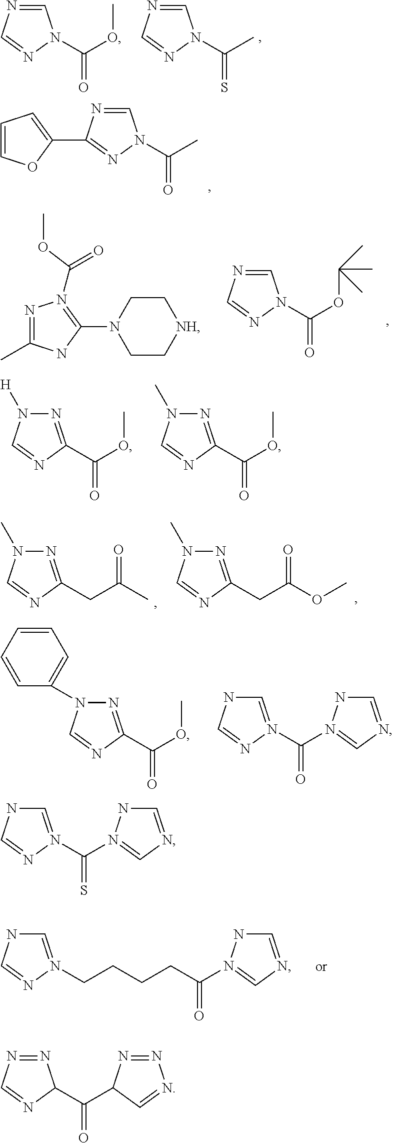

4. The electrolyte according to claim 1, wherein based on a total weight of the electrolyte, a percentage of the compound represented by formula (I) is n wt %, wherein n is 0.01 to 6.

5. The electrolyte according to claim 4, further comprising a first additive, wherein the first additive comprises at least one of fluoroethylene carbonate or vinylene carbonate; and based on the total weight of the electrolyte, a percentage of the first additive is m wt %, wherein m>0, and −1≤m−n≤18.

6. The electrolyte according to claim 1, further comprising a second additive, wherein the second additive comprises at least one of a compound represented by formula (II) or a compound represented by formula (III): 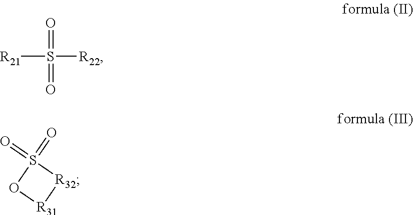
wherein,
R₂₁ and R₂₂ are each independently selected from substituted or unsubstituted C₁-C₂₀ alkyl groups, substituted or unsubstituted C₂-C₂₀ alkenyl groups, substituted or unsubstituted C₂-C₂₀ alkynyl groups, substituted or unsubstituted C₆-C₃₀ aryl groups, substituted or unsubstituted C₁-C₂₀ alkoxy groups, substituted or unsubstituted C₂-C₂₀ alkenyloxy groups, substituted or unsubstituted C₂-C₂₀ alkynyloxy groups, or substituted or unsubstituted C₆-C₃₀ aryloxy groups, and when at least one of R₂₁ or R₂₂ is substituted, a substituent group is halogen;
R₃₁ is selected from substituted or unsubstituted C₁-C₄ alkylidene groups or substituted or unsubstituted C₂-C₄ alkenylene groups;
R₃₂ is selected from a bond, substituted or unsubstituted C₁-C₂ alkyleneoxy groups, —O—, or —R₃₃—SO₂—R₃₄—;
R₃₃ is selected from substituted or unsubstituted C₁-C₂ alkylidene groups;
R₃₄ is selected from a bond, substituted or unsubstituted C₁-C₂ alkylidene groups, or —O—; and
when at least one of R₃₁, R₃₂, R₃₃, or R₃₄ is substituted, a substituent group is C₁-C₂₀ alkyl groups, C₆-C₃₀ aryl groups, halogen, or —CN; and
based on a total weight of the electrolyte, a percentage of the second additive is 0.05 wt % to 10 wt %.

7. The electrolyte according to claim 6, wherein the second additive comprises at least one of the following compounds:

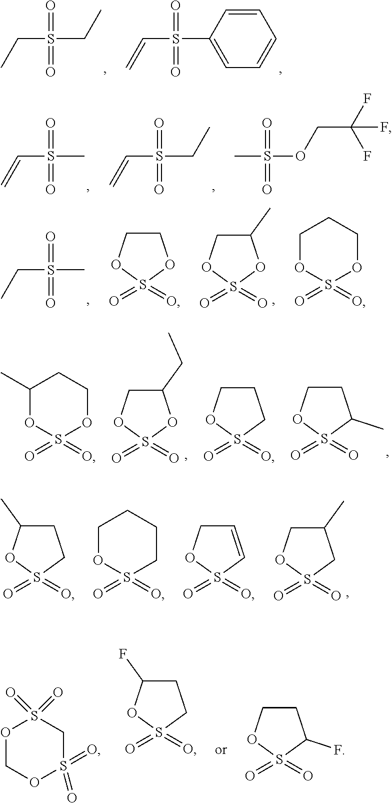

8. The electrolyte according to claim 1, further comprising a third additive, wherein the third additive comprises at least one of a compound having two nitrile groups or a compound having three or more nitrile groups; the compound having two nitrile groups comprises at least one of a compound represented by formula (IV) or a compound represented by formula (V); and the compound having three or more nitrile groups comprises at least one of a compound represented by formula (VI) or a compound represented by formula (VII); 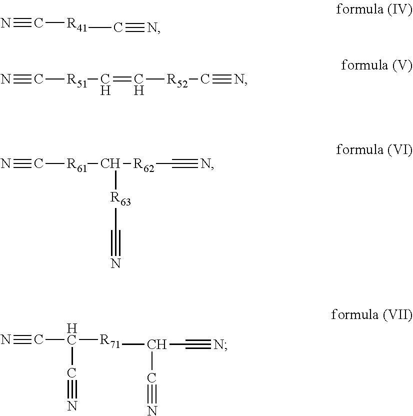
wherein,
R₄₁ is selected from substituted or unsubstituted C₁-C₁₂ alkylidene groups or —R^{c}—(O—R^{a})_{A}—O—R^{b}, and R^{a} and R^{b} are each independently selected from substituted or unsubstituted C₁-C₃ alkylidene groups, R^{c} is selected from a bond or substituted or unsubstituted C₁-C₃ alkylidene groups, wherein A is an integer between 0 and 2;
R₅₁ and R₅₂ are each independently selected from a bond or substituted or unsubstituted C₁-C₁₂ alkylidene groups;
R₆₁, R₆₂, and R₆₃ are each independently selected from a bond, substituted or unsubstituted C₁-C₁₂ alkylidene groups, or substituted or unsubstituted C₁-C₁₂ alkyleneoxy groups;
R₇₁ is selected from a bond, substituted or unsubstituted C₁-C₁₂ alkylidene groups, substituted or unsubstituted C₂-C₁₂ alkenylene groups, substituted or unsubstituted C₅-C₁₂ cycloalkylene groups, substituted or unsubstituted C₆-C₂₆ arylidene groups, or substituted or unsubstituted C₂-C₁₂ heterocyclylene groups; and
when at least one of R₄₁, R₅₁, R₅₂, R₆₁, R₆₂, R₆₃, or R₇₁ is substituted, a substituent group is halogen; and
based on a total weight of the electrolyte, a percentage of the third additive is 0.1 wt % to 12 wt %.

9. The electrolyte according to claim 8, wherein the third additive contains at least one of malononitrile, butanedinitrile, glutaronitrile, adiponitrile, heptanedinitrile, octanedinitrile, sebaconitrile, 3,3′-oxydipropionitrile, hex-2-enedinitrile, fumaronitrile, 2-glutenonitrile, methylglutaronitrile, 4-cyanopimelonitrile, (Z)-but-2-enedinitrile, 2,2,3,3-tetrafluorosuccinonitrile, ethylene glycol bis(propionitrile) ether, 1,3,5-pentanetricarbonitrile, 1,3,6-hexanetricarbonitrile, 1,2,6-hexanetricarbonitrile, 1,2,3-tris(2-cyanooxy)propane, 1,1,3,3-propanetetracarbonitrile,

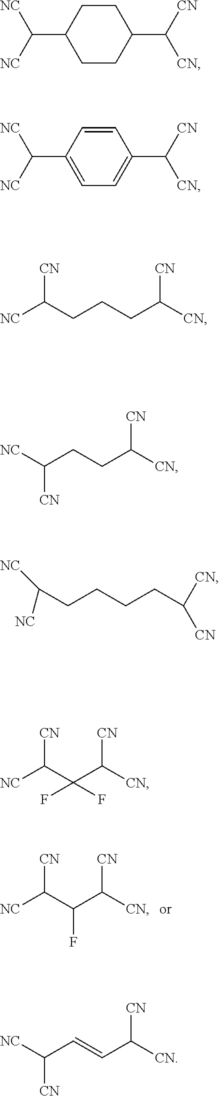

10. The electrolyte according to claim 8, wherein the third additive comprises the compound having two nitrile groups and the compound having three or more nitrile groups; based on the total weight of the electrolyte, a percentage of the compound having two nitrile groups is x wt %, and a percentage of the compound having three or more nitrile groups is y wt %, wherein x−y≥0.

11. The electrolyte according to claim 1, further comprising a fourth additive, wherein the fourth additive comprises at least one of LiCH₃SO₃, LiCF₃SO₃, LiN(SO₂CF₃)₂, LiC(SO₂CF₃)₃, LiBOB, or LiDFOB; and based on a total weight of the electrolyte, a percentage of the fourth additive is 0.05 wt % to 2 wt %.

12. An electrochemical apparatus, comprising a positive electrode, a negative electrode, and an electrolyte, wherein the electrolyte comprises a compound represented by formula (I) 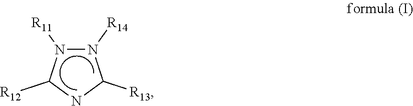
wherein,
R₁₁, R₁₂, R₁₃, and R₁₄ are each independently selected from a hydrogen atom, substituted or unsubstituted C₁-C₂₀ hydrocarbyl groups, or substituted or unsubstituted C₁-C₂₀ organic functional groups containing heteroatoms; and
at least one of R₁₁, R₁₂, R₁₃, or R₁₄ is 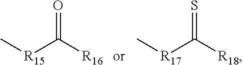
wherein:
R₁₅ and R₁₇ are each independently selected from a single bond, substituted or unsubstituted C₁-C₄ alkylidene groups, substituted or unsubstituted C₂-C₄ alkenylene groups, or substituted or unsubstituted C₆-C₁₀ arylene groups; and
R₁₆ and R₁₈ are each independently selected from substituted or unsubstituted C₁-C₁₀ hydrocarbyl groups or substituted or unsubstituted C₁-C₁₀ organic functional groups containing heteroatoms;
wherein the heteroatom is selected from at least one of oxygen, nitrogen, sulfur, phosphorus, silicon, or aluminum; and
when at least one of R₁₁, R₁₂, R₁₃, R₁₄, R₁₅, R₁₆, R₁₇, or R₁₈ is substituted, a substituent group is halogen or —CN.

13. The electrochemical apparatus according to claim 12, wherein the compound represented by formula (I) comprises at least one of compounds represented by formula (I-a) to formula (I-d): 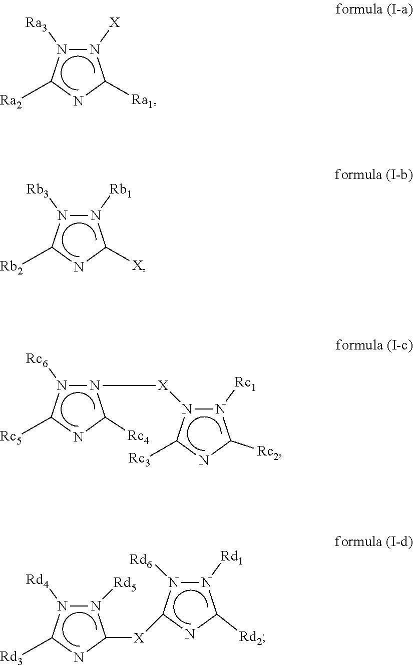
wherein,
X is 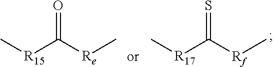
Ra₁, Ra₂, Ra₃, Rb₁, Rb₂, Rb₃, Rc₁, Rc₂, Rc₃, Rc₄, Rc₅, Rc₆, Rd₁, Rd₂, Rd₃, Rd₄, Rd₅, and Rd₆ are each independently selected from a hydrogen atom, substituted or unsubstituted C₁-C₂₀ alkyl groups, substituted or unsubstituted C₂-C₂₀ alkenyl groups, substituted or unsubstituted C₂-C₂₀ alkynyl groups, substituted or unsubstituted C₆-C₃₀ aryl groups, substituted or unsubstituted C₁-C₂₀ alkoxy groups, substituted or unsubstituted C₂-C₂₀ alkenyloxy groups, substituted or unsubstituted C₂-C₂₀ alkynyloxy groups, substituted or unsubstituted C₆-C₃₀ aryloxy groups, carboxyl group, ether group, carbonyloxy group, sulfhydryl group, cyan group, amido group, carbonamide group, substituted or unsubstituted C₁-C₁₆ siloxy groups, C₁-C₁₆ alumina alkyl groups, substituted or unsubstituted C₁-C₁₀ saturated cycloalkyl groups, substituted or unsubstituted furanyl groups, substituted or unsubstituted pyranyl groups, substituted or unsubstituted piperidinyl groups, substituted or unsubstituted piperazinyl groups, substituted or unsubstituted pyrrolyl groups, substituted or unsubstituted pyrazolyl groups, substituted or unsubstituted pyrazinyl groups, substituted or unsubstituted pyridazinyl groups, substituted or unsubstituted imidazolyl groups, substituted or unsubstituted triazolyl groups, substituted or unsubstituted thienyl groups, substituted or unsubstituted thiazolyl groups, or substituted or unsubstituted oxazolyl groups;
R₁₅, Rₑ, R₁₇, and R_{f} are each independently selected from a bond, substituted or unsubstituted C₁-C₄ alkylidene groups, substituted or unsubstituted C₂-C₄ alkenylene groups, or substituted or unsubstituted C₆-C₁₀ arylidene groups; and
when at least one of Ra₁, Ra₂, Ra₃, Rb₁, Rb₂, Rb₃, Rc₁, Rc₂, Rc₃, Rc₄, Rc₅, Rc₆, Rd₁, Rd₂, Rd₃, Rd₄, Rd₅, Rd₆, Rₑ, or R_{f} is substituted, a substituent group is halogen, C₁-C₆ alkyl groups, or —CN.

14. The electrochemical apparatus according to claim 12, wherein based on a total weight of the electrolyte, a percentage of the compound represented by formula (I) is n wt %, wherein n is 0.01 to 6.

15. The electrochemical apparatus according to claim 12, wherein the electrolyte further comprises a second additive, wherein the second additive comprises at least one of a compound represented by formula (II) or a compound represented by formula (III): 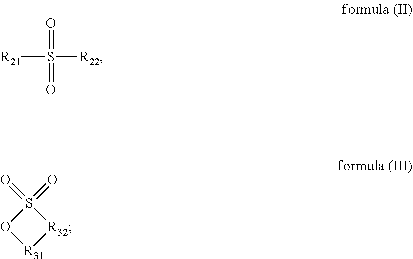
wherein,
R₂₁ and R₂₂ are each independently selected from substituted or unsubstituted C₁-C₂₀ alkyl groups, substituted or unsubstituted C₂-C₂₀ alkenyl groups, substituted or unsubstituted C₂-C₂₀ alkynyl groups, substituted or unsubstituted C₆-C₃₀ aryl groups, substituted or unsubstituted C₁-C₂₀ alkoxy groups, substituted or unsubstituted C₂-C₂₀ alkenyloxy groups, substituted or unsubstituted C₂-C₂₀ alkynyloxy groups, or substituted or unsubstituted C₆-C₃₀ aryloxy groups, and when at least one of R₂₁ or R₂₂ is substituted, a substituent group is halogen;
R₃₁ is selected from substituted or unsubstituted C₁-C₄ alkylidene groups or substituted or unsubstituted C₂-C₄ alkenylene groups;
R₃₂ is selected from a bond, substituted or unsubstituted C₁-C₂ alkyleneoxy groups, —O—, or —R₃₃—SO₂—R₃₄—;
R₃₃ is selected from substituted or unsubstituted C₁-C₂ alkylidene groups;
R₃₄ is selected from a bond, substituted or unsubstituted C₁-C₂ alkylidene groups, or —O—; and
when at least one of R₃₁, R₃₂, R₃₃, or R₃₄ is substituted, a substituent group is C₁-C₂₀ alkyl groups, C₆-C₃₀ aryl groups, halogen, or —CN; and
based on a total weight of the electrolyte, a percentage of the second additive is 0.05 wt % to 10 wt %.

16. The electrochemical apparatus according to claim 12, wherein the positive electrode comprises a positive electrode active material, the positive electrode active material contains first particles and second particles, and an average particle size of the first particles is greater than an average particle size of the second particles.

17. The electrochemical apparatus according to claim 16, wherein the first particle and the second particle have the same or different chemical compositions.

18. The electrochemical apparatus according to claim 16, wherein the second particles contain element aluminum, and based on a total weight of the positive electrode active material, a percentage of element aluminum is 0.001 wt % to 1 wt %.

19. An electronic apparatus, comprising an electrochemical apparatus, wherein the electrochemical apparatus, comprises a positive electrode, a negative electrode, and an electrolyte, wherein the electrolyte comprises a compound represented by formula (I): 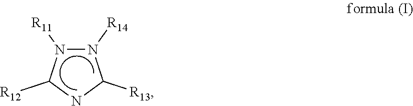
wherein,
R₁₁, R₁₂, R₁₃, and R₁₄ are each independently selected from a hydrogen atom, substituted or unsubstituted C₁-C₂₀ hydrocarbyl groups, or substituted or unsubstituted C₁-C₂₀ organic functional groups containing heteroatoms; and
at least one of R₁₁, R₁₂, R₁₃, or R₁₄ is 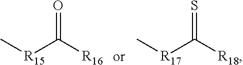
wherein:
R₁₅ and R₁₇ are each independently selected from a single bond, substituted or unsubstituted C₁-C₄ alkylidene groups, substituted or unsubstituted C₂-C₄ alkenylene groups, or substituted or unsubstituted C₆-C₁₀ arylene groups; and
R₁₆ and R₁₈ are each independently selected from substituted or unsubstituted C₁-C₁₀ hydrocarbyl groups or substituted or unsubstituted C₁-C₁₀ organic functional groups containing heteroatoms;
wherein the heteroatom is selected from at least one of oxygen, nitrogen, sulfur, phosphorus, silicon, or aluminum; and
when at least one of R₁₁, R₁₂, R₁₃, R₁₄, R₁₅, R₁₆, R₁₇, or R₁₈ is substituted, a substituent group is halogen or —CN.

20. The electronic apparatus according to claim 19, wherein the compound represented by formula (I) comprises at least one of compounds represented by formula (I-a) to formula (I-d): 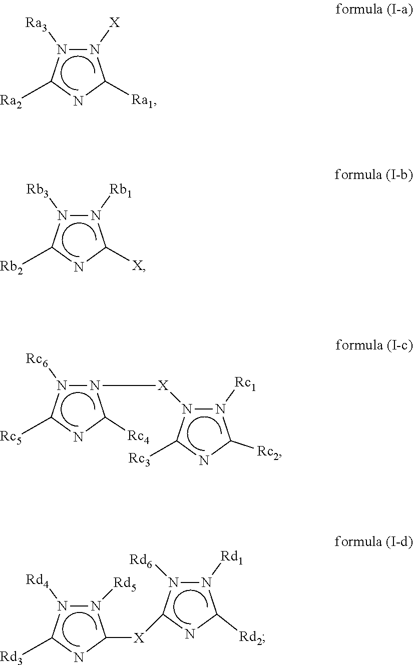
wherein,
X is selected from 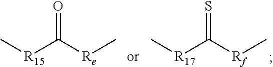
Ra₁, Ra₂, Ra₃, Rb₁, Rb₂, Rb₃, Rc₁, Rc₂, Rc₃, Rc₄, Rc₅, Rc₆, Rd₁, Rd₂, Rd₃, Rd₄, Rd₅, and Rd₆ are each independently selected from a hydrogen atom, substituted or unsubstituted C₁-C₂₀ alkyl groups, substituted or unsubstituted C₂-C₂₀ alkenyl groups, substituted or unsubstituted C₂-C₂₀ alkynyl groups, substituted or unsubstituted C₆-C₃₀ aryl groups, substituted or unsubstituted C₁-C₂₀ alkoxy groups, substituted or unsubstituted C₂-C₂₀ alkenyloxy groups, substituted or unsubstituted C₂-C₂₀ alkynyloxy groups, substituted or unsubstituted C₆-C₃₀ aryloxy groups, carboxyl group, ether group, carbonyloxy group, sulfhydryl group, cyan group, amido group, carbonamide group, substituted or unsubstituted C₁-C₁₆ siloxy groups, C₁-C₁₆ alumina alkyl groups, substituted or unsubstituted C₁-C₁₀ saturated cycloalkyl groups, substituted or unsubstituted furanyl groups, substituted or unsubstituted pyranyl groups, substituted or unsubstituted piperidinyl groups, substituted or unsubstituted piperazinyl groups, substituted or unsubstituted pyrrolyl groups, substituted or unsubstituted pyrazolyl groups, substituted or unsubstituted pyrazinyl groups, substituted or unsubstituted pyridazinyl groups, substituted or unsubstituted imidazolyl groups, substituted or unsubstituted triazolyl groups, substituted or unsubstituted thienyl groups, substituted or unsubstituted thiazolyl groups, or substituted or unsubstituted oxazolyl groups;
R₁₅, Rₑ, R₁₇, and R_{f} are each independently selected from a bond, substituted or unsubstituted C₁-C₄ alkylidene groups, substituted or unsubstituted C₂-C₄ alkenylene groups, or substituted or unsubstituted C₆-C₁₀ arylidene groups; and
when at least one of Ra₁, Ra₂, Ra₃, Rb₁, Rb₂, Rb₃, Rc₁, Rc₂, Rc₃, Rc₄, Rc₅, Rc₆, Rd₁, Rd₂, Rd₃, Rd₄, Rd₅, Rd₆, Rₑ, or R_{f} is substituted, a substituent group is halogen, C₁-C₆ alkyl groups, or —CN.
